(19) United States
(12) Patent Application Publication
(10) Pub. No.: US 2023/0252540 A1
(43) Pub. Date: Aug. 10, 2023

(54) User applications store and connecting, registering, following with and synchronizing or accessing user data of user applications from/to parent application and other user applications

(71) Applicant: Yogesh Rathod, Mumbai (IN)

(72) Inventor: Yogesh Rathod, Mumbai (IN)

(21) Appl. No.: 18/134,782

(22) Filed: Apr. 14, 2023

Related U.S. Application Data
(63) Continuation of application No. PCT/IB2021/059112, filed on Oct. 5, 2021.
Application No. PCT/IB2021/059112 is a continuation of application No. PCT/IB2020/059671, filed on Oct. 15, 2020.

(51) Int. Cl. G06Q 30/0601; G06Q 50/00

(52) U.S. Cl. CPC G06Q 30/0607; G06Q 50/01

(57) ABSTRACT

In various embodiments, receiving request to publishing or listing and making searchable, the user application of a user and receiving, a request from a parent application of the user, to open one or more user applications. Receiving, from the first user, follower information indicative of one or more other users including second user and third user to be followed by the first user and storing the follower information in the storage. Receiving from a first application associated with the first user from a first source, first content for distribution, receiving from a second application associated with the second user from a second source, second content for distribution. Identifying followers of the second user and the third user and sending the message to the followers of the second user, including the first user and sending the message to the followers of the third user, including the first user.

### FIELD OF INVENTION

The present invention relates generally to user application store, wherein user can upload application or generate application and verify, publish and make them searchable for other users of network. Users of network can search other users' applications and can follow and access followed user's related application or directly click or tap on application and access application or authorized part of or features or content of application or install applications and access installed application of other users or send connection request(s) to one or more users of network and in the event of acceptance of connection request access connection request accepted user's application. Users of network can also access other users applications based on triggering of events or more types of triggers or identification of one or more types of user activities, identification of nearby connected or related or authorized users, identification of location or place, recognition of face or body of person or code including QR code or object, suggested list of applications based on plurality of factors. In another embodiment verified user enable to upload, generate, verify, update, and publish user application within parent application or connect with parent application via API and enable other users of network to follow or connect or install or open and access other users related application or application associated profile, contents, user actions or call-to-actions and reaction controls. In another embodiment enabling authorized user to manage related contents, connections, viewers, followers, application features, advertisements within parent application. In another embodiment user of first network or application can access related data on second network or application. In another embodiment enabling user to transfer or access user related data or content and followers or connected or related users associated with one or more external domains or applications to one or more other domains or applications. In another embodiment enabling second network or application to identify or determine eligibility, rank, wight and offers of user on first network or application. In another embodiment enabling integrated mini apps or extremal applications or websites to instantly create mass userbase by synchronizing relevant or filtered or as per requirement specification or rule based or filtered or contextual or subscribed user account information or data from the server database of parent application or website or domain or network to integrated mini apps or extremal applications or websites based on user permission and privacy settings.

### BACKGROUND OF THE INVENTION

Currently App stores including Apple™ App Store and Google™ play store enables developers to upload, verify and publish applications which are searchable for searching users of network and user can select, download, install, register, log-in and use the installed application. But theses app stores does not enable user to upload and create or generate user application which other users of network can follow, connect, and with one tap or one click can access user application based on detection of user activities and plurality of factors including nearby location, scan object or code or face, phone contacts, incoming call or video call or message or email, viewing, listening, talking, interacting, making payment or transact, subscribing, buying, selling, get appointment, participate in event, join group, install application, visit place, participate in group deal, participate in collaboration, participate in task or workflow, publishing or viewing contents, searching, sharing, booking, connecting, following, add to list, schedule, calendar entries, user profile, user related updated data or logs or status from one or more linked systems.

At present social networks including Twitter™, Facebook™, TikTok™, Instagram™, WhatsApp™, Helo™, Sharechat™ and other social networks and applications enables multiple users on network to register, publish contents, follow or connect other users, take actions and provide reactions on posted contents. But followers and posted contents of users are possessed by said networks where user registers. User does not enable to create their own user base, create and manage application, customize user interface, introduce new features, publish advertisements and monetize the user bae and contents.

At present celebrities, known parsons and super nodes having thousands or millions of followers, viewers and connections on one or more external domains including Facebook, Snapchat, Instagram, Twitter, YouTube, LinkedIn and other social networks and applications having hundreds or thousands of posted posts, photos, videos, tweets, live videos, short videos, stories, and millions of reactions including comments, likes, shares. But these 3rd parties or external domains, websites, social networks and applications does not share or allow to access user related data of followers, viewers and connections with user, user does not have complete control over customization and complete content access rights and monetize user base by providing other features. Present invention enables user to create user application which integrated or linked with parent application and parent application share or allow to access user's followers, viewers, connections and registered user's data and shared contents by user on parent network with user's own user application. So, user can independently monetize or publish user application, post contents from user application on parent network, customize application, offer new features, and monetarize userbase. User's user generated contents, data, data of followers, viewers and connections can access by user application.

Present invention enables user to access and use user profile, posted contents, data related to followers or users, lists, statistics and reactions on posted contents on external domain or application related to user to user's own application which are connected to said external domain(s) or application(s) or network(s) or other users' applications. So, user can create userbase on external network(s) and posts contents on external network(s) and also create or add said userbase on user's own application.

Present invention enables already popular celebrities, authorized user or eligible users to develop, generate, upload, submit, verify, list, making searchable application for enabling other users of network to follow or register user or user application for receiving posted contents from followed sources. Ussr of network can follow said eligible users from central search engine. In the event of contents posted by eligible users via their own connected application with parent application or network or sever, receiving by the parent application or network or sever from the eligible user's application, posted contents, identifying by the parent application server, followers and sending by the parent application server, said posted contents to followers on each follower's application or central feed interface.

At present cloud services enables user to store user generated contents on cloud storage. But it lacks full features client application for management of contents including post, view, publish, share, enable for followers or connected or selected users, view followers, connections and reactions, take actions and like.

Truecaller™ app enables user to view name of called user while outgoing call and view name of caller user while incoming call. But it does not enable user to view and access application of called user while outgoing call and application of caller user while incoming call. So, user can view past notes, agenda of call, make notice, record and store call, share documents or one or more types of contents, take one or more actions and provide one or more types of reactions.

Fiverr act as middlemen and enables listed user to publish, provide, workflow, manage service(s) to service consumers or users of network. But middlemen restrict customization of user interface and offers and increases cost of service. There is need of user application, so user to user direct providing and consuming of services take place.

At present each applications or websites need to create userbase for providing products and services or offering features or contents. For creating userbase there is need to spend lot of time, money and energy. There is no mechanism to instantly create relevant and contextual mass userbase. Present invention enables integrated mini apps or extremal applications or websites to instantly create mass userbase by synchronizing relevant or filtered or as per requirement specification or rule based or filtered or contextual or subscribed user account information or data from the server database of parent application or website or domain or network to integrated mini apps or extremal applications or websites based on user permission and privacy settings.

Therefore, it is with respect to these considerations and others that the present invention has been made.

### OBJECT OF THE INVENTION

The principal object of the present invention is to enable personal or user app store, platform, network and connections. User can develop, create, generate and upload, verify, publish and make searchable user application on user applications store, so other user can search, install, invite and in the event of acceptance of invitation use user application, follow and use application of followed sources, and use other users applications based on plurality factors including phone contacts, mutual connections, following to other users, email address, privacy settings, preferences, nearby users, pre-defined triggers including automatically display other user's application based on incoming call associated caller, incoming message or notification sender, current location or place, recognition of voice or face or body of connected or related users, detection of nearby connected or related users and any combination thereof.

The other object of the present invention is identifying rank, weight, offers, eligibility of/for user based on number of posts or contents published, number of followers, connections and reactions on posted contents by user on one or more external networks or applications.

The other object of the present invention is to enable user to one click or tap open user app without user need to download, install, register, log-in, update, and uninstall applications of users. User can directly tap or click on user application and can open or access or use application.

The other object of the present invention is to enable users of external network(s) to access user application from user profile, user posted contents or post, via message or uniform resource locator (URL) or scanning of face or code including QR code or voice command or from one or more types of lists including suggested list.

The other object of the present invention is to enable user to prepare one or more types of contents within user application and then post or publish to one or more social networks, and applications.

The other object of the present invention is to enable parent network or application to provide ready and contextual userbase to other internal or integrated or external applications or websites. Parent network or application automatically download, install, register and log-in contextual applications. Server of parent network or application transfer or synchronize relevant user data of contextual users of parent network or application from server database of parent network or application to one or more integrated mini or sub or child applications or installed applications or external applications. So, from userbase of parent network or application or website, plurality of integrated mini or sub or child applications or installed applications or external applications can instantly create userbase and monetize applications, websites and services and enable users to instantly use relevant and contextual applications.

The other object of present invention is to enable eligible users to register with parent network and create, generate, develop, upload, submit, verify, publish, list, and register application to connect with parent server, network and application and enable viewing users of network to search, match, visit profile and follow selected one or more said eligible users or associated applications and receive and view contents from followed sources from their respective application and data source on single user interface and enable to unfollow, reply, like, dislike, rate, reshare, comment on received one or more types of contents including posts, photos, videos, stories, messages, micro blogs, short videos, audio, uniform resource locator (URL), files, location information, emoticons and any combination thereof.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Embodiments described herein enabling user application store or parent application for registering, creating, generating, developing, uploading submitting, verifying, publishing, listing, making searchable, searching, matching, suggesting, displaying user application from/within user application store or parent application. User can open, access, add, follow, connect, categories, rank, share, sort, filter, order, remove, unfollow, disconnect, block one or more user applications. Enabling to add, link and integrate one or more mini applications in/within user application, wherein mini applications develop, submit, verify, make searchable, publish, list and update by external or 3rd parties registered developers. In another embodiment parent application can synchronize user related one or more types of authorized data and content to user application. In another embodiment parent application can synchronize user application related one or more types of authorized data and content from/to external domains.

In one embodiment, present invention teaches enablement of private network within parent application or website or sandbox wherein user or authorized or verified user or paid user can store and manage their various types of digital contents on their own storage medium including cloud storage via cloud account, store, manage and view their own connections, viewers and followers, develop, customize, configure, register, upload, verify and make available one or more applications, web services websites, webpages, application features, objects, controls, forms, widgets for searching users, users of network, own connections, followers and viewers, manage advertisers, advertisement models, advertisements, manage and update profile, draft, post or publish one or more types of contents. Users (for example fans, prospective followers, customers, prospective customers and like) of network can only follow or connect said authorized or verified or paid users of network including celebrities, artists, politicians, famous persons, television serial actors, singers, sports persons, local personalities, any paid, verified and authorized user, products, services, sellers, professionals, brands, companies, organizations and can view their posted or sent or published contents. Authorized, verified, paid, logged-in user can create, manage own private network within parent application. General users of network need to install, update, upgrade and register only parent application and can browse categories directories of authorized, verified, paid users including celebrities, brands, companies, and enterprise users, and search authorized, verified, paid users including celebrities, brands, companies, and enterprise users and connect them or follow them or directly view their posted contents on feed or timeline or profile page, wherein contents presented from different servers or cloud storage of corresponding or respective authorized, verified, paid users including celebrities, brands, companies, and enterprise users. Advertisers can search, select, make payment as per advertisement models of one or more authorized, verified, paid users including celebrities, brands, bloggers, companies, and enterprise users and prepare and post advertisements with target criteria, wherein displaying advertisements in feed of said selected one or more authorized, verified, paid users including celebrities, brands, companies, and enterprise user, so their viewing users or connections or followers can view said advertisements within their feed. In an embodiment general user not allowed to post contents, not allowed to follow any other general users of network, not allowed to view numbers of and details of followers of followed sources, not allowed to re-share contents. In an embodiment enabling authorized, verified, paid users including celebrities, brands, companies, and enterprise users to post contents with one or more types of call-to-actions, user actions and controls including buy, follow, connect, view, book, share contact details, send message, make call, participate, make payment, subscribe, claim reward, install call-to-actions, so viewing of followers or connected users can take one or more actions or call-to-actions. Central search engine enables users to search, match, view details or profiles of authorized, verified, paid users including celebrities, brands, companies, and enterprise users and enable to connect, follow and view their contents. In an embodiment parent application creates child application and private network for each authorized, verified, paid users including celebrities, brands, companies, and enterprise users for enabling them to manage their own contents, connections, followers, applications, advertisements and transactions, view statistics, analytics related their own user base including viewers, followers, connections and advertisers. General users can view contents related to followed or connected or selected sources. General users can select users from list suggested users and can follow, connect and view their contents, wherein suggestion based on location, current event, current movie or show, current location associated place of business, scanning of face including face of celebrities in movie or real show, voice recognition, preferences, interests, search keywords, other followed sources details, logged activities and like.

In another embodiment enabling authorized or eligible user or user's application to register, connect with parent application or network server or user application store or network or server via application programming interface (APIs) and software development toolkit (SDKs) and synchronize followers, viewers and registered users of user or related to user from parent application or server or database to user application or server or database. In another embodiment enabling authorized or eligible user or user's application to register, connect with parent application or network server or user application store or network or server via application programming interface (APIs) and software development toolkit (SDKs) and synchronize followers, viewers and registered users of user or related to user from user application or server or database to parent application or server or database.

In another embodiment enabling first domain including website, application, social network, serve, database to connect with second domain including website, application, social network, serve, and synchronizing (including pull or push snapshot, merge and transactional synchronization as per rules, structured query language (SQL) or queries, triggers) followers or connected users or viewers or users of user data from first domain to second domain or from second domain to first domain based on permission of first domain and second domain as per rules, subscriptions, criteria, queries or structured query language (SQL) or target criteria.

In an embodiment receiving a request from client device to register a user; registering the user; receiving request from the client device to submit a user application for publication; publishing and making searchable user application; receiving request from the parent application of the client device, to open the user application of the plurality of user applications; opening the user application within or from the parent application.

In an embodiment receiving request from the parent application of client device to follow user application or user application associated user.

In an embodiment receiving request from the parent application of client device to connect user application or user application associated user.

In an embodiment receiving request from the parent application of the client device to display contextual or suggested or relevant or matched user applications based on following, connections, phone contacts, email contacts from one or more accounts, mutual connections, followers, followed sources, viewers, registered users of user on one or more external domains, applications and services based on social or professional network and instant messaging accounts, identified current location or location associated place or place associated contextual activities or checked-in place, identified entered pre-defined geofence, identified nearby users or one or more types of interacted contextual entities, monitored and tracked schedules, alarms, incoming calls, messages, contents and notifications, calendar entries, logged activities, actions, participations, interactions, transactions, locations, entities, updates, status, sharing, communication, collaboration, recognized scanned code including QR code, face or object or body, detected voice of nearby identified or contextual persons, voice command, search query, past search history, past user applications history, bookmarks, connection requests, contacts of contacts, required or assigned or searched or ending tasks, requirement specification, one or more types of user and connected users related data and profile, keywords, tags one or more types of filters, match making criteria, user preferences, privacy settings, date and time, rules and triggering of one or more types of pre-defined or updated triggers and executing of rules from pre-defined rules base and any combination thereof.

In an embodiment receiving request from the parent application of the client device to unfollow particular followed source or particular user application; unfollow requesting user with said particular followed source.

In an embodiment receiving request from the parent application of the client device to disconnect particular connection user or user application; unfollow requesting user with said particular connection user or user application.

In an embodiment receiving search query from the parent application of the client device to search user applications and associated one or more types of contents and data; searching user applications and associated one or more types of contents and data based on search query.

In an embodiment receiving request from the parent application of the client device to sort, filter, remove, order, rank, block, share, categories, add notes, add to one or more types of system or user created lists user applications.

In an embodiment receiving request from the parent application of the client device to post or share or publish or send one or more types of contents including one or more posts, messages, micro blogs, stories, photos, videos, short videos, audio, files, status, reactions, emoticons or stickers, location information and uniform resource locator (URL) to one or more selected external domains including web sites, applications, servers, databases, networks, platforms and devices for followers or all or selected connected users on said one or more selected external domains.

In an embodiment receiving registration request from a developer of mini applications for user applications; registering developer of mini applications for user applications; receiving request from the registered developer of mini applications to submit one or more mini applications for publication; publishing and making searchable mini applications for user applications; receiving request from the user application within parent application to add or link or integrate one or more mini applications with user application; add or link or integrate one or more mini applications with user application; receiving request from the user to open selected mini application from or within user application which opened from or within the parent application; directly or one click or one tap opening selected mini application from or within user application without user need to download, install, register, update, uninstall and reinstall and login.

In an embodiment sharing or synchronizing or allow to access one or more types of authorized data with user application and one or more mini applications added or integrated with user application, wherein data comprises login information, user profile, user created or posted or shared data or contents, one or more types of logged data.

In an embodiment in the event of a first user following or connecting or registering to a second user on a first network or an application or a platform or a website or a service, transferring pre-determined one or more types of data or contents including user profile, one or more types of reactions of first user and one or more types of posted contents of the second user to the second application or website or database or network related or associated to the second user.

In an embodiment in the event of first user following or connecting or registering to a second user on first network or application or platform or website or service, transferring pre-determined one or more types of data or contents including user profile, one or more types of reactions of first user and one or more types of posted contents of the second user to the second application or website or database related or associated to the second user; and in the event of third user following or connecting or registering to a second user on second network or application or platform or website or service, transferring pre-determined one or more types of data or contents including user profile, one or more types of reactions of first user and one or more types of posted contents of the second user to the first application or website or database related or associated to the second user.

In an embodiment receiving from the user, name of external domain or application or social network or website, unique identity or profile uniform resource locator (URL) on external domain or application or social network or website, profile photo associated with external domain or application or social network or website; receiving from the camera application of user device, live or real-time or current video or photo of user; matching user profile photo with said extracted image inside live or real-time or current video or photo of user based on face or body recognition; in the event of sufficiently matching of user profile photo with said extracted image inside live or real-time or current video or photo of user automatically or manually identifying data, statistics, analytics including number of followers, connections, contacts, viewers, views, posted contents, one or more types of actions and reactions on posted contents related to user on said external domain or application or social network or website; and determining eligibility and ranking of user or determining offer for user.

In an embodiment allowing a parent application to access applications related to each user of a parent network; enabling users to follow or subscribe or connect or register one or more applications or users of the parent network associated with corresponding application; and enabling users to view received or displayed contents or call-to-actions from/of followed or subscribed or connected or registered sources on central interface or on application associated with followed or subscribed or connected or registered sources.

In an embodiment synchronizing users account data related to first application or website from a first domain or network or database or server to the database of a second domain or network or application or server, wherein first domain or network or database or server is external to second domain or network or database or server.

In an embodiment data comprises encrypted password, payments detail and one or more types of sensitive information. In an embodiment synchronization comprises pull, push, snapshot, merge, and transactional synchronization.

In an embodiment wherein user account data comprises data of selective or rule based or searched or matched as per preferences or categories or filtered or subscribed or pre-determined or related including followers, connected users, contacts of contacts or suggested users of the first domain or network or application or database or server.

In an embodiment enable user to automatically or manually login application or website related to the second domain or network or database or server.

In an embodiment enabling developer or user to submit one or more mini applications with one or more types of details including name, title, category(ies), tags or keywords, icon or logo, screenshots, description, and system data and metadata including version number, data and time; receiving request from the developer or user to verify submitted mini applications; in the event of successful verification, publishing mini applications and making them searchable for users of network; and wherein user can select, customize, add or integrate one or more mini applications with user application.

In an embodiment receiving request from the user application within parent application, adding or integrating or customizing one or more selected mini applications; adding or integrating or enabling user to customize and add or integrate one or more selected mini applications with user application or within user application; receiving request from the user application within parent application, open selected mini application from or within user application, wherein user can directly open user application within parent application and user application associated said selected mini application within user application without user need to download, install, register, login, update, uninstall user app.

In an embodiment receiving request from the external domain or application or website or server or database to pull one or more types of authorized data from user application or mini application within user application within parent application; synchronizing said pulled data from the user application to the external domain or application or website or server or database.

In an embodiment receiving request from a user client device to download and install a user application store application; downloading and installing the user application store application in the user client device; receiving request from the user application store application installed within the user client device to register with the user application store or server or network or platform of user application store; registering the user application store application; receiving request from the user client device to create or generate or upload or submit for verification, a user application with details; verifying the user application and listing, publishing and making searchable user application for users of network; receiving request from the user client device to open selected user application within the user application store application; and directly opening and enabling to access selected user application from the user application store application without user need to download, install, register, login, update, and uninstall or reinstall user application.

In an embodiment receiving request from a user client device to download and install a user application store application; downloading and installing the user application store application in the user client device; receiving request from the user application store application installed within the user client device to register with the user application store or server or network or platform of the user application store; registering the user application store application; receiving request from the user client device to create or generate or upload or submit for verification, the user application with details; verifying the user application and listing, publishing and making searchable the user application for users of network; receiving request from the user client device to open selected user application within the user application store application; and directly opening and enabling to access selected user application from or within the user application store application without user need to download, install, register, login, update, and uninstall or reinstall user application; receiving request from the user application to add or integrate selected one or more mini applications with or within user application; adding or integrating selected one or more mini applications with or within user application; receiving request from the user to open selected mini application within or from user application; and directly opening and enabling to access selected mini application within or from user application without user need to download, install, register, login, update, and uninstall or reinstall mini application.

In an embodiment receiving request from the user client device to verify user based on one or more verification techniques and verifying user based on one or more verification techniques.

In an embodiment receiving, from the first user, follower information indicative of one or more other users including second user and third user to be followed by the first user; storing the follower information in the storage; receiving from a first application associated with the first user from a first source, first content for distribution; receiving from a second application associated with the second user from a second source, second content for distribution; identifying, by a computer processor, followers of the second user, wherein the first user is among the followers; identifying, by a computer processor, followers of the third user, wherein the first user is among the followers; sending the message to the followers of the second user, including the first user; and sending the message to the followers of the third user, including the first user. In an embodiment receiving a request from a user to become eligible to generate or upload, verify and list application and register for enabling other users of network to follow user; in the event of identifying eligibility enabling user to generate or upload, verify and list application and register for enabling other users of network to follow user.

In another embodiment enable user to follow other users of network based on searching of profiles including user names or user identities of users of network and tapping or clicking on search result item associated embedded or integrated or presented follow button or icon or link or control. In another embodiment enable user to follow other users of network based on searching of posted contents or posts of users of network by tapping or clicking on search result item associated embedded or integrated or presented follow button or icon or link or control to follow source(s) associated with search contents. In another embodiment enable user to follow other users of network based on visiting web site or profile page or web page of user(s) and tapping or clicking on profile page or webpage associated embedded or integrated or presented follow button or icon or link or control.

In an embodiment present invention employ service worker enabled progressive web application (PWA) which is a type of application software delivered through the web, built using web technologies including HTML, CSS and JavaScript. It is intended to work on any platform that uses a standards-compliant browser, including both desktop and mobile devices. Since a progressive web app is a type of webpage or website known as a web application, they do not require separate bundling or distribution. User or developer can develop, generate, upload, submit, verify, register, store, publish, list user progressive web applications (PWAs) or other progressive web applications (PWAs) on user applications store or user applications platform for other users of network. Developers can just publish the web application online, list progressive web application on user application platform ensure that it meets baseline “installability requirements”, and users will be able to add the application to their home screen. Publishing the app to digital distribution systems like Apple App Store or Google Play is optional. A web application is considered a PWA if it satisfies “installability criteria” and thus can work offline and can be added to device home screen. To meet this definition, all PWAs require a minimum of a service worker and a manifest. Some progressive web apps use an architectural approach called the App Shell Model. In this model, service workers store the basic User Interface or “shell” of the responsive web design web application in the browser's offline cache. This model allows for PWAs to maintain native-like use with or without web connectivity. This can improve loading time, by providing an initial static frame, a layout or architecture into which content can be loaded progressively as well as dynamically.

A service worker is a web worker that implements a programmable network proxy that can respond to web/HTTP requests of the main document. It is able to check the availability of a remote server and to cache content when that server is available, and serve that content later to the document. Service workers, like any other web workers, work separately from the main document context. Service workers can handle push notifications and synchronize data in the background, cache or retrieve resource requests, intercept network requests and receive centralized updates independently of the document that registered them, even when that document is not loaded. Service workers essentially act as proxy servers that sit between web applications, the browser, and the network (when available). They are intended, among other things, to enable the creation of effective offline experiences, intercept network requests and take appropriate action based on whether the network is available, and update assets residing on the server. They will also allow access to push notifications and background sync APIs.

Service worker syntax is more complex than that of AppCache, but service workers use JavaScript to control AppCache-implied behaviors with a fine degree of granularity, allowing it to handle this problem and many more. Using a Service worker it's possible to easily set an app up to use cached assets first, thus providing a default experience even when offline, before then getting more data from the network (commonly known as Offline First). This is already available with native apps, which is one of the main reasons native apps are often chosen over web apps.

Data replication (e.g., Microsoft™ SQL Data Replication) including snapshot, merge, transactional publication and pull and push subscriptions enables synchronization of data and File synchronization enables one-way or merge file synchronizations.

Installing a progress web app is very fast (within a few seconds). Progress web app is associated with or accessible via uniform resource locator (URL).

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic. One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines. Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system). Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program. The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a network diagram depicting a network system having a client-server architecture configured for exchanging data over a network implementing various embodiments of creating, submitting, verifying, publishing, updating, upgrading, integrating and linking selected mini applications, searching, selecting and invoking or using user application(s) and user application store and platform.

FIG. 2 illustrates components of an electronic device implementing various embodiments of uploading, submitting, searching, selecting, invoking and accessing or using user application and user application store or parent application or network.

FIGS. 3-4 illustrates user application store application functionalities including creating, generating, uploading, registering user application and displaying, searching, adding, following, accessing, connecting with user applications o other users of network.

FIG. 5 illustrates graphical user interface (GUI) of preparing, editing and augmenting one or more types of contents including post, story, photo, video, short video, message, tweet and save, preview and post or publish or advertise or share or send to one or more contacts, viewers, followers and connected users or user applications of network and/or one or more selected external domains, applications, social networks, websites, servers, databases, networks, devices and platforms.

FIG. 6 illustrates graphical user interface (GUI) of central feed or newsfeed or timeline application or feature of parent application or user applications store application.

FIG. 7 illustrates graphical user interface (GUI) for enabling user to upload one or more types of contents or upload one or more types of contents on or related to one or more external domains, applications, websites and local storage of user's one or more devices or cloud storage. User can install and register parent application, optionally upload contents, create or generate and customize user application and select and customize, integrate or link one or more mini applications with said user application.

FIG. 8 illustrates graphical user interface (GUI) of central feed or newsfeed or timeline application or feature of parent application or user applications store application, wherein viewing user can view post of publishing user and can also view post publisher's use application to access more types of contents, customized features, services and call-to-actions.

FIG. 9 illustrates graphical user interface (GUI) of exemplary user application.

FIG. 10 illustrates block diagram describing user applications store or platform, in-network applications, super nodes applications, user applications, external applications and direct and indirect connections, rule base sharing between or among them and sharing formulations among them.

FIG. 11 is a block diagram that illustrates a mobile computing device upon which embodiments described herein may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

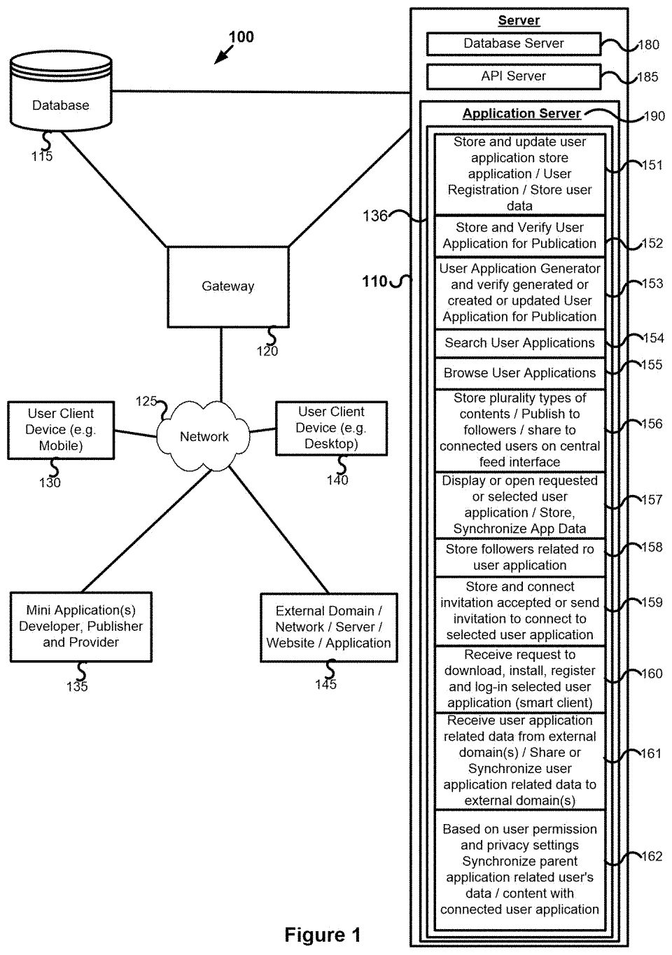

FIG. 1 illustrates an example user application store platform, network and system, under an embodiment. According to some embodiments, system 100 can be implemented through software that operates on a portable computing device, such as a mobile computing device. System 100 can be configured to communicate with one or more network services, databases, objects that coordinate, orchestrate or otherwise provide search results, user applications and associated posts, actions and reaction controls, monitoring activities and actions and generating and presenting feed. Additionally, the mobile computing device can integrate third-party services which enable further functionality through system 100.

The system for accessing registered parent application or user application store application for developing, creating, generating, uploading or submitting for verification, verifying, publishing and making user application searchable for other users of network for enabling other users to open and access or follow or connect user application, access or view or receive posted contents, access one or more features, mini applications and call-to-actions based on user application associated user's permission, access rights and policies and privacy settings. While FIG. 1 illustrates a gateway 120, a database 115 and a server 110 as separate entities, the illustration is provided for example purposes only and is not meant to limit the configuration of the user application store, platform and network and managing user application system. In some embodiments, gateway 120, database 115 and server 110 may be implemented in the user application store, platform and network and managing user application system as separate systems, a single system, or any combination of systems.

As illustrated in FIG. 1, the user application store, platform and network and managing user application system may include a user application associated use's user device or mobile devices 130 and other user(s) of network including authorized user or follower or connected user of user application or viewer of user application related user device or mobile devices 130. Devices or Mobile devices 130/140 may be particular set number of or an arbitrary number of devices or mobile devices which may be capable of downloading, uploading, registering, searching, viewing, presenting, posting, sharing, publishing, broadcasting, advertising, sending, matching, accessing and managing user applications, one or more types of users of network, contents, user related data, search results, mini applications, call-to-actions. Each device or mobile device in the set of user application user's 130/140 and user of said user's user application's device or mobile devices 130/140 may be configured to communicate, via a wireless connection, with each one of the other mobile devices or devices 130/140/135/145. Each one of the mobile devices or devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the user application store, platform and network and managing user application system may include gateway 120. Gateway 120 may be a web gateway which may be configured to communicate with other entities of the user application store, platform and network and managing user application system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of the user application store, platform and network and managing user application system. In various embodiments, gateway 120 may be connected to database 115 and/or server 110 via a wired or a wireless network connection.

Gateway 120 may be configured to send and receive search queries, search results, posted contents, search results associated or user selected user application(s) one or more types of contents including posts, videos, photos, short videos, stories, messages, location information, followers, connections, contacts, mini applications, call-to-actions to/from mobile devices 130/140/135/145. Gateway 120 may be configured to send and receive one or more types of user data comprises user profile, user connections, connected users' data, user shared data or contents, user logs, activities, actions, events, senses, transactions, status, updates, presence information, locations, check-in places and like to/from mobile devices 130/140/135/145. For example, gateway 120 may be configured to receive registration, verification, updated contents or posts and user application(s) access request, search queries and receive information or logged data about monitored or tracked search related activities, actions, status, events, reactions and transactions of searching user from client devices 130/140, receive contents posted and updated by user associated with user application from client devices 135/145 to database 115 for storage.

As another example, gateway 120 may be configured to serve or send search query specific user applications or contents including collection of categories posts, photos, videos, multimedia, texts, locations and associated actions and reactions controls or GUIs to searching user, requesting user, followers and viewers stored in database 115 to mobile devices 130/140. Gateway 120 may be configured to receive search requests from mobile devices 130/140 for searching and presenting user applications and/or associated contents with search result.

For example, gateway 120 may receive a request from a mobile device and may query database or index database or sabotage medium 115 with the request for searching and matching request specific or search query specific matched search results including user applications, one or more types of user or other users of network posted one or more types of contents including posts, photos, videos, short videos, messages, sources, contacts, followers, and users of networks. Gateway 120 may be configured to inform server 110 of updated data. For example, gateway 120 may be configured to notify server 110 when a new or updated post, user application, logged activities, actions, events, transactions, status, reactions has been received from a mobile device or device of user application owner or posting or publishing or content broadcaster(s) or provider(s) stored on database 115.

As illustrated in FIG. 1, the user application store, platform and network and managing user application system may include a database, such as database 115. Database 115 may be connected to gateway 120 and server 110 via wired and/or wireless connections. Database 115 may be configured to store a database of registered user's profile, accounts, posted or shared contents, user applications, mini applications, features, Add-ons, call-to-actions, user actions and reaction controls, followed sources, user data including logged activities, actions, events, transactions, reactions, status, communication, sharing, updates, behaviors, searching activities and payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, search query specific search result, search query specific contents of user application(s) including posts, photos, videos, messages, microblog, call-to-actions, mini applications, multimedia, text, links or URLs, location information, actions and reactions controls and GUIs, user profile, user data, posted or shared contents, user followers, following users, viewers, contacts or connections, reacted users profile, number of reactions related to particular type of reaction, user or provider account's related data which meet the criteria specified in the request. Database 115 may be configured to communicate with server 110.

As illustrated in FIG. 1, the user application store, platform and network and managing user application system may include a server, such as server 110. Server may be connected to database 115 and gateway 120 via wired and/or wireless connections. As described above, server 110 may be notified, by gateway 120, of new or updated user application or connected or followed source's or user's content, user profile, user data, user posted or shared contents, actions and reactions, user followed sources and various types of status stored in database 115.

FIG. 1 illustrates a block diagram of the user application store, platform and network and managing user application system configured to implement the platform where user(s) can register, upload or submit developed, created, generated, user application, search or view suggested contextual user applications, contents including posts, photos, video, short videos, message, story, data, and associated actions and reactions controls or GUIs to searching user, followers, and requesting or viewing users. While FIG. 1 illustrates a gateway 120, a database 115 and a server 110 as separate entities, the illustration is provided for example purposes only and is not meant to limit the configuration of the user application store, platform and network and managing user application system. In some embodiments, gateway 120, database 115 and server 110 may be implemented in the user application store, platform and network and managing user application system, a single system, or any combination of systems.

The server 110 stores database server 180, API server 185 and application server 190 which stores applications, modules, services, APIs, web services including user applications store application, registration, create, generate, verify, search, match, display and store user applications, mini applications and contents, synchronize user related data from/to external networks to implement operations of various embodiments of the invention and may include executable instructions to access a client device which coordinates operations disclosed herein. Alternately, may include executable instructions to coordinate some of the operations disclosed herein, while the client device implements other operations.

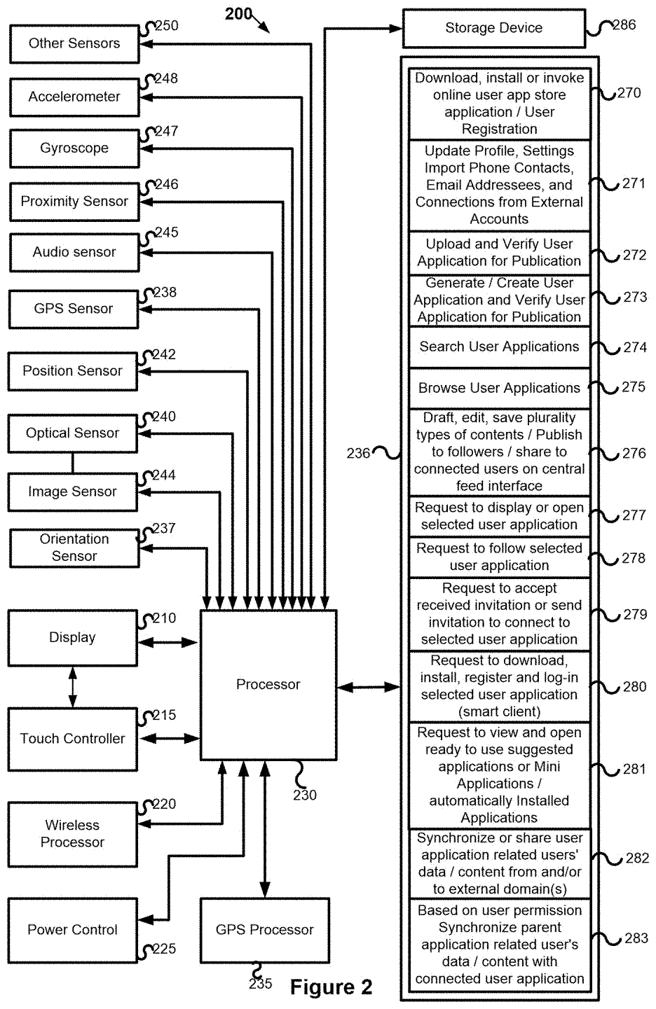

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random-access memory. The memory 236 stores user application store application (Smart Client or Web based) 270, user application (mini applications—no need user to download, install, register and login (use parent application or user app store application login) 272/273 to implement operations of one of the embodiments of the invention. The user applications store application (Smart Client or Web based) 270 may include executable instructions to access a client device and/or a server which coordinates operations disclosed herein. Alternately, the user applications store application (Smart Client or Web based) 270 may include executable instructions to coordinate some of the operations disclosed herein, while the server implements other operations.

The processor 230 is also coupled to image sensors 238. The image sensors 238 may be known digital image sensors, such as charge coupled devices. The image sensors capture visual media, which is presented on display 210. The image sensors 238 capture visual media and present the visual media on the display 210 so that a user can observe the captured visual media.

A touch controller 215 is connected to the display 210 and the processor 230. The touch controller 215 is responsive to haptic signals applied to the display 210.

The electronic device 200 may also include other components commonly associated with a smartphone, such as a wireless signal processor 220 to provide connectivity to a wireless network. A power control circuit 225 and a global positioning system (GPS) processor 235 may also be utilized. While many of the components of FIG. 2 are known in the art, new functionality is achieved through the user application store application and user application, search application, feed application and communication application operating in conjunction with a server.

FIG. 2 shows a block diagram illustrating one example embodiment of a mobile device 200. The mobile device 200 includes an optical sensor 244 or image sensor 238, a Global Positioning System (GPS) sensor 235, a position sensor 242, a processor 230, a storage 236, and a display 210.

The optical sensor 244 includes an image sensor 238, such as, a charge-coupled device. The optical sensor 244 captures visual media. The optical sensor 244 can be used to media items such as pictures and videos.

The GPS sensor 238 determines the geolocation of the mobile device 200 and generates geolocation information (e.g., coordinates including latitude, longitude, aptitude). In another embodiment, other sensors may be used to detect a geolocation of the mobile device 200. For example, a WiFi sensor or Bluetooth sensor or Beacons including iBeacons or other accurate indoor or outdoor location determination and identification technologies can be used to determine the geolocation of the mobile device 200.

The position sensor 242 measures a physical position of the mobile device relative to a frame of reference. For example, the position sensor 242 may include a geomagnetic field sensor to determine the direction in which the optical sensor 240 or the image sensor 244 of the mobile device is pointed and an orientation sensor 237 to determine the orientation of the mobile device (e.g., horizontal, vertical etc.).

The processor 230 may be a central processing unit that includes a media capture application 270.

The media capture application 270 includes executable instructions to generate media items such as pictures and videos using the optical sensor 240 or image sensor 244. The media capture application 270 also associates a media item with the geolocation and the position of the mobile device 200 at the time the media item is generated using the GPS sensor 238 and the position sensor 242.

The storage 236 includes a memory that may be or include flash memory, random access memory, any other type of memory accessible by the processor 230, or any suitable combination thereof. The storage 236 stores the media items generated or shared or received by user and also store the corresponding geolocation information, auto identified system data including date & time, auto recognized objects in photo or image(s) of video associated keywords, metadata, and user provided information. The storage 236 also stores executable instructions corresponding to the Search Application, Feed Application, Communication Application, Web Browser/Mobile Browser, Map Application and Push Notification.

The display 210 includes, for example, a touch screen display. The display 210 displays the media items generated by the media capture application 270. A user captures, records and selects media items for drafting and posting one or more types of contents or adding to one or more types of posts or feeds, stories or galleries by touching the corresponding media items on the display 210. A touch controller monitors signals applied to the display 210 to coordinate the capturing, recording, and selection of the media items.

The mobile device 200 also includes a transceiver that interfaces with an antenna. The transceiver may be configured to both transmit and receive cellular network signals, wireless data signals, or other types of signals via the antenna, depending on the nature of the mobile device 200. Further, in some configurations, the GPS sensor 238 may also make use of the antenna to receive GPS signals.

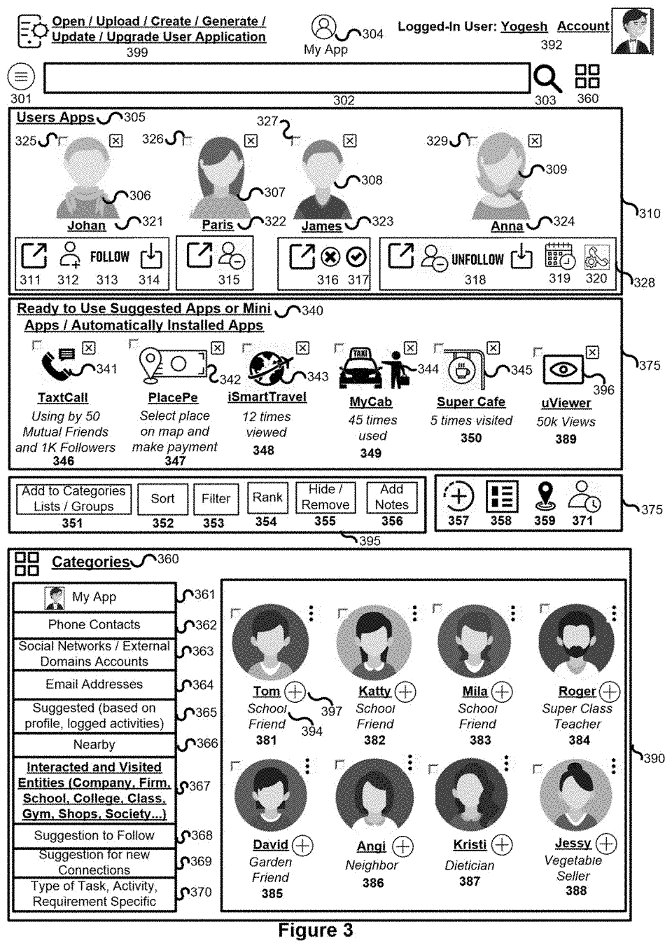

FIG. 3 illustrates exemplary graphical user interface of personal or user application store or suggested mini applications or automatically installed application store. User can download, install or use web application, register, log-in and use personal or user application store or suggested mini applications or automatically installed application store (hereinafter, referred to as “user application store”). User device 200 send request 270 to download and install user application store application or send request to invoke or open or access web-based user application store application online to server 110 module 151. After downloading, installing user application store application or opening web-based user app store application, user can send registration request 270 including user name, profile photo, mobile number, email address, one or more types of unique user identity (UID) and password from user device 200 to sever 110 module 151. Server module 151 send one-time password (OTP) on user device 200 of said mobile number for user and user associated user device verification. Server module 151 can employ various user verification techniques to verify user and user identity and user data. After registering with the application store user can login by using one or more types of login methods including entering unique user identity and password or via voice or via face or via fingerprints (biometric). In an embodiment during registration or after log-in server module 151 request user to allow server module 151 to import phone contacts, email addresses and social account connections and in the event of providing importing of phone contacts, email addresses and social accounts related connections permission, server module 151 imports phone contacts, email addresses and social account connections and identify associated user applications or identify users who installed or not installed user app store and identify users who upload or create and register user application. In an embodiment user can send request via module 271 to server module 151 to update, process and sore one or more types of use profiles including general profile (age, birthdate, gender, education, skills, home and work address, interests, contact information), job profile, health profile, travel profile, food profile, dating or matrimonial profile, business profile, interest profile and other types of profiles, add or update one or more payment accounts information, privacy settings, presentation settings, preferences, provide one or more types of permissions including allow to access location and accurate location information to identify nearby user applications of contacts or other users of network, allow to access contacts to identify user application of phone contacts, allow to access accounts on device including import or access email addresses to identify user applications related to email addresses, allow to access external domains including social network accounts identify user applications related to connections of external domains including social networks accounts, allow to access user device camera to receive scanned or captured images to identify scanned or captured images associated objects, code including QR code, face or body associated user application, allow to access incoming emails or messages from selected email accounts or messenger accounts to identify emails or messages contents including named entities, tasks, schedule, transacted one or more types of entities related applications, allow to access calendar including calendar events associated with one or more selected accounts to identify calendar entries, notes, schedule, participants, members, meetings, appointment associated user applications, allow to access microphone and allow to record audio to identify user surround detected voice associated identified users or persons associated user applications, allow to access phone to automatically open incoming call related or associated user application(s), allow to access storage and files & media to enable user to securely store contents in local storage and retrieve contents, allow to access SMS to send notification regarding suggested, nearby, contextual, current activity(ies), status, task, place, nearby friends specific user application(s).

In an embodiment after registering with the user apps store user can develop and submit with details including app name, app icon or logo, screenshots, description, what's new notes, auto generated version number and date & time of creation or updates, category, title, tags or keywords, creator and support name and contact information, update, upload and verify user application or mini application or application via user device 200 user app store application module 272 to server module 152 for making them searchable or listed on app store for other users of network.

In an embodiment after registering with the user apps store, user can create or generate user application 273 based on step by step or wizard or using series of graphical user interfaces and providing, selecting, filling, importing profile details including age, gender, name, home and office address, maps and direction, social account names, interests, payment account details, contact information, contents, data, forms, call-to-actions or user actions controls, reaction controls, features, customization and presentation settings, privacy settings, preferences, various types of user permissions to access user device sensors, resources, applications, continents, contacts and data, importing phone contacts, importing connections based on social accounts details, and one or more types of fields associated one or more types of values. User can provide, add or update user application name, icon, category(ies), selected tags or keywords, screenshots, description, support name and contact information, access rights, policies, and privacy settings for user data, contents, actions and features for other users of network including all users of network or public, all or one or more selected contacts, groups and connections including friends, family, best friends, and private or for user only. User can input, import, format, select or use drag and drop to select plurality types of contents including photos, videos, uniform resource locators (URLs), files, emoticons, location information and user data, User can customize user interface of application, wherein customization includes size, color, font, background, style, schema, look and feel of user interface. After providing all said required details including mandatory or optional details, user can save details or generate or create user application. User can update said details and re-generate or re-create or update or upgrade user application. In another embodiment user can search and select or select one or more mini applications and associate, add, integrate with user application and provide or set or update access rights, policies, rules and privacy settings for other users of network including private or for users own purpose or all or selected contacts, mutual connections, followers, groups, filtered or queried users of network and other user applications, external domains, websites, applications, services, databases, networks, devices and servers, wherein mini applications and user actions may comprises e-commerce, buying, selling, group deals, booking, payment, order, jobs, dating, referrer, support, appointment, games, task and workflow management, calendar, alarms, notification, content creation, publishing and viewing, notes, phone call management, activity management, health management, travel management, collaboration, communication, sharing, updating status, clock, various types of calculator, time and money management, profile management, connection management related mini apps and call-to actions.

In an embodiment after creating or generating or updating user application, user can submit user application for verification 271 to serve 110 module 153. After completion of verification, server module 153 or 152 listing user application with details or making user application searchable or available for other users of network. In an embodiment after creating or generating or updating user application, user can submit user application for publication. In an embodiment after creating or generating or updating user application, user can use application for personal use or make it private.

In an embodiment users of network can send search query via search module 274 to server module 154 for searching 303 search query specific user applications of other users of network wherein search query 302 may include one or more keywords, types of user applications, categories, commands, syntax, Boolean operators, structured query language (SQL), locations, places, types of activities, types of users, profile field including name, age range, gender, education, company name, type of relationship, type of interest, school name, college name, contact information including phone number, email address, user name, social account name, photo or image of user, user application name, connection, following, currently interacted, nearby, requinto type of task specific, type of filters, type of node of network, type of call-to-action(s) or feature(s) or mini application(s) associated with user application, type of content, type of allowed access rights (public, in mutual connection, follower, followed sources, in phone contact, in email address, private) to searching user specific and any combination thereof. Server 110 module 154, receives search query and retrieves search query specific data and contents from server database or storage 115 and generates search results and display search results 306/307/308/309 in user app store search result interface 310 with associated actions (311-325). In an embodiment by default server 110 module 154 display suggested user applications on graphical user interface (GUI) 275 of client device based on plurality of factors including rank of application which determined based on number of connections, views, followers, reactions and associated activities, user profile data, logged user activities including current location, or current location associated place, nearby contacts or interacted entities and relationships including client, customer, guests, seller, buyer, host, viewer, patient, subscriber, participant, invite, invitor, teacher, student, trainer, dietician, commuter, owner, employer, employee, professional, partner, associates, colleagues, listener, member and like, nearby liked stores or products, invitation, contacts of contacts, visiting of users profile, bookmarked or liked, installed, added to list, transacted, visited place, linked systems associated user data, advertisement by user applications, mutual connections, similar interests, activities, participation in event, school, college, workplace, society, user preferences, user age, gender, past logged searches and activities and picked by server admin(s).

In another embodiment server 110 module 155 receive request to browse user applications 275. User can browse categories user applications, wherein categories comprises all 361, user's phone contacts 362 to view imported or added or updated phone contacts or incoming and outgoing calls related phone number associated user applications, user's social network accounts or external networks, websites, applications 363 related connections including mutual connections, professional connections, customer connections, email addresses 364 related user applications, suggested 365 user applications wherein server 110 module 155 suggest user applications based on pre-defined rules, privacy settings, interests, updated status, updated data associated with user from user data or from linked external domains or databases or applications or systems, digital activities including installed applications, visited websites, e-commerce, purchased products online, participate in group deals, making payment, receiving an viewing notification, viewing profile page on external domain, chatting, video call conversation, updating of status or workflow or task status, participant members in collaborative activities, communication, logged activities, current activities, past activities, future or upcoming or scheduled activities, calendar entries, set reminders or alarms, updates, visited place related service providers, society members, rank of connections, contacts, and followers, participated or membership of event, group, network, forum, club, buying of products, subscribing of services, join class, upgrade to next year of school or college, search query, user's call-to-actions, nearby 366 users associated user applications, wherein identify user device nearby users for user based on identification of nearby contacts, identification of current location associated place or entering into pre-defined geofence and in the event of dwelling for pr-set duration identify associated staff or person associated user applications, scanned QR code nearby users, identification of commuter, recognition of voice, nearby family members based on home address, nearby staff or employees based on work or office address, identified event place associated nearby users, in-person meeting venue or place associated nearby users, nearby customers or preference specific or similar customers, interacted various types of entities 367 associated user applications, wherein interacted various types of entities comprises employee, home worker, watchman, waiter, cab driver, friends, family members, seller, service provider, on-demand service provider, doctor, nurse, hotel or restraint staff, club members, nearby users at particular event, professionals, police, government employees, students, teachers, patients, class mates, society members, shop owner or admin or manager, courier person, person at pump, suggested user application 368 for following, wherein suggestion based on user profile (education, skill, work, location, favorite activities, reactions), interests, preferences, and linked external domains related user data, suggestion for new connections related user applications 369, wherein suggesting new connection based on schedules of meeting, upcoming events, similar profiles associated persons, new home, class, school, colleges, upgrade to academic class or year, visiting new place, nearby friends of friends, contacts of contacts, relatives and types of task, activity, action and requirement specification 370 specific user applications. For example, in the event of selection of interacted entities category 367 from list of categories of user applications 360, displaying list of user applications related to interacted entities 381-388. User can select one or more user applications and can add to one or more types of lists 351 or add 397 or hide from displayed list 355 or further sort 352 or filter 353 and then select and add to one or more types of lists 351. In an embodiment user can view details of relationship(s) 395 including student, classmate, teacher, doctor, customer, client, buyer, seller, member, patient, viewer, attendee, listener, host, celebrity, and like, number of times meet or interacted or visited, communicated, nearby, similar profile, transacted and total amount.

In an embodiment user can provide unique and original user name or nick name or search and select or search, select and make payment for any available name in network for user application.

In an embodiment in the event of clicking or tapping on particular application icon 311, sending request to open said selected user application icon 311 associated user application from module 277 to sever 110 module 157 to directly open user application 306 based on permission and access rights provided by user application 306 associated user 322. User 392 can view publicly available post posted or published by user 306. User 392 can view task or work or service provider profile of user and can select task, communicate, negotiate, make full or partial payment, assign work, manage task, view status of workflow, request revision and get task done from user 321 associated with user application 306. User 392 can view professional profile or business profile or work profile of user 321 associated with user application 306 and can send message or select consulting type, communicate, make full or partial payment (if paid), get consultancy, provide reactions or send invitation to connect with user or send job opportunities details. User can take one or more actions on allowed or public part including content, profiles, user application integrated mini applications and features, wherein action may comprises participate in deals published in user application 306, buy listed products and services, market or sell products and services, book and schedule appointment, ask question, provide answer, claim offer or provide offer including discount, coupon, voucher, free sample, invitation at particular event, cash back, redeemable points, ask to install application, participate in group, like profile, offer job, ask for job, instruct to provide service, provide one or more types of reactions including comments, provide tips, make suggestion, feedbacks and complaints, make partnership offer, make payment, display advertisement, request to become friends or sports or travel group member with details, offer or get on-demand service, offer or request funding.

In an embodiment user 392 can send invitation to connect 312 to selected user application associated user from module 279 to server 110 module 159 and in the event of accepting of connection request by said user, connecting user 392 with said connection request accepted user 321 and displaying said user application 306 in list of connected users 403 of user 392. In an embodiment enabling user to post contents or converse among connected users and view posted contents or messages by connected users. In an embodiment connected users can take one or more actions or call-to-actions including ask for particular amount of required money, provide books or ask to give books and offer cloths and claim cloths with or without disclosing identity, request to refer or recommend for job, task, requirement, business, partnership, bank loan, doctor, matrimonial, ask queries, organize and schedule meeting, travel, visit, order, participate in event or group deals plan, offer partnership or become part of particular project or investment including venture, group buying, share investment, construction, retailing, and like, communication (send message, email, make text or voice or video call), collaboration, content sharing, view status and updates, view today's menu made by user, view today's plan (travel, visit mall or shop for shopping partier types of products, plan to view particular movie, listed songs, eat food or plan to eat particular food at particular restaurant so other user can view details including date, time, venue or location or place, type of activity and participate in activity.

In an embodiment user 392 can send request to follow 313 from module 278 to server 110 module 158 for following selected application 306 associated user 321. Server 110 module 158, stores and relate or associate said unique identity of user 392 as following user with user 321.

In an embodiment followers and connected users can view one or more types of contents including microblog, message, short video, photos, videos, ephemeral contents, stories, posts posted by followed or subscribed sources in central feed or news feed or timeline 358 or updates or status or updates in location 359/371 or ephemeral stories or stories 357 graphical user interface provided by parent application or user app store, wherein user notified about newly posted contents by followed sources and can view updated contents, take one or more types of reactions including comment, chat, like, share, reply, provide one or more types of emoticons, emojis, stickers. In an embodiment posting or publishing user of one or more types of contents or user generated contents can prepare, draft, edit, import, save contents 276 in user application 236 of client device 200 and allow to view or access based on privacy settings including allow to view or access to all users of network (public), only user can view or access (private), allow to view or access by followers or all or selected connected users or groups or one or more types or query specific or filtered users of network via server module 156. In an embodiment user first draft, prepare, edit and save contents in user application and then send request from module 282 via server 110 module 161 to/from share, publish, synchronize, send one or more types of contents on external domains, websites, applications, databases, platforms, networks and servers including Twitter™, Facebook™, Google™, Snapchat™, Instagram™, WhatsApp™, Skype™, LinkedIn™, YouTube, Local Language Social network applications and like. In an embodiment user can allow selected external domains, applications, websites, servers, networks, platforms and databases to pull or pull synchronize allowed or selected or updated contents from user application from module 282 via server 110 module 161. In another embodiment external domains, applications, websites, servers, networks, platforms and databases enables user application to pull one or more types of contents posted by user or related to user or allow to access by user from external domains, applications, websites, servers, networks, platforms and databases via application program interface (APIs) and software development toolkit (SDKs). In an another embodiment based on permission by user application and one or more external domains, applications, websites, servers, networks, platforms and databases, enabling both user application and said external domains, applications, websites, servers, networks, platforms and databases to base on snapshot, merge, transactional pull and push synchronization exchange or share or update or synchronize one or more types of contents including posts, messages, microblog, short videos, photos, videos, stories, uniform resource locator (URLs), files and user profile, user application userbase data and profile, user data including privacy settings, preferences, logged or posted user activities, status, locations or checked-in places, and updates, mini applications, reactions including comments, rank, like, dislike and one or more types of resources, contents, data, objects, applications, settings, logs.

In an embodiment user 392 can download 314 selected downloadable user application 306. User application comprises mini application (user can click or tap on name or link or icon of mini app to directly open app, no need to download, install, register, log-in, update, uninstall or re-install or) or smart client application (e.g. Android™ and iOS based user application—need to download, install and can register and login via parent application or external domain log-in via feature and also need to update, upgrade and uninstall or re-install), web based online application.

In an embodiment user 392 can disconnect particular connected user 322 via tapping or clicking on “dis-connect” icon or control 315 associated with user application 308.

In an embodiment user 392 can accept 317 or reject 316 or ignore invitation to connect from particular user 323.

In an embodiment user 392 can take one or more actions 316, 319, 320 manually selected by user 324 associated with user application 309 and/or automatically display or show or hide beside or with user application icon 309 which associated with the user application, wherein automatically display user actions to user 392 based on calendar entries associated with viewing user 392 and application 309 user 324, current location or identification of particular location or location associated place or pre-defined geofence provided by user 324, current date and time, schedule, privacy settings including do not disturb settings, rules, identification of nearby user or scanning of user face or body, identification of user home or office location, mutual connection including friends, in phone or email contact, in professional contact, in social network connection, customer, client, guest, patient, relationships and like, following or follower, updates, posting of stories or posts or one or more types of contents, updates in location, incoming message, incoming call including video or voice, live video publication.

In an embodiment user application icon associated with user application. In an embodiment one or more types of user actions or reactions or all to action icons or link or name or controls including automatically or manually selected or identified by parent application, user application, user of user application, connected users of user of user application and user application associated mini applications) associated with user application.

For example, user 392 can view automatically displayed calendar icon 319 based on scheduled meeting with user 324 associated with user application 309 and user actions 328. In the event of completion of meeting or schedule date and time, automatically hide calendar icon 319 from list of user actions 328. In another example in the event of incoming call from user 324 associated with user application 309 automatically displaying phone call management icon 320. Another types of actions comprises view stories, view updates including posts and status, view updated current location or checked-in place for enabling user to meet at that place, send birthday or anniversary or work anniversary gift based on event date associated with the user 324, send birthday or anniversary or work anniversary party invitation or reminder based on event date associated with the user 392, view and claim exclusive offer, view new stocks exclusively first priority to user 392, view new or updated status of assigned task or work or project, view one or more types of invitations, updates, offers, communications, activity (ies), call-to-actions.

In another embodiment enabling user to select one or more user applications and enable user to take one or more group actions including add selected one or more user applications to particular user created or system provided lists or groups or categories or automatically identify user applications based on plurality of factors, user related data including user profile, connections, logged activities, rules, pre-defined triggers and parameters, wherein lists or groups or categories comprises best friends, club members, task related, activity related, requirement related, project related, customers, clients, guests, relatives, best relatives, patients, subscribers, service providers, on-demand service providers, shops, neighbors, travel members, current, bookmarked, liked, favorite, employees, home workers, partners, colleagues or associates, type of professionals specific, school friends, college friends, particular interest related, particular game related, one or more attributes related including best friends of class 10 at school, discounted product sealer of particular item, society members having particular age range and gender, activity specific connected users currently at particular location, today's guests at particular place, viewers of particular movie at particular theater at particular date and time, viewers of advertisements at particular show at particular date and time at particular location and like.

In another embodiment enabling user to sort 352 and filter 34 displayed user applications based on name, location, type, keyword, category, date and time of created or updated, task, age range, gender, activity, type of entity, birth date, rank and wight, most frequently used, number of times used, interest, in connections or contacts, visited place, transacted entity, shop, nearby, and any combination thereof.

In another embodiment enabling user to select one or more user applications and enable user to provide rank 354.

In another embodiment enabling user to select one or more user applications and enable user to hide or remove user applications from displayed list 310.

In another embodiment enabling user to select one or more user applications and enable user to provide or update notes 356.

In an embodiment enabling user to click or tap on mini application 341 to directly open and access mini application 341 from displayed set of mini applications 375 without user need to download, install, register and login, wherein mini applications developed, submitted for verification and publication by 3^{rd} parties' developers. In another embodiment in the event of click or tap on application 342 automatically download, install, register and log-in (based on parent application user profile data and login information) application 342 and based on user permission and privacy settings synchronizing one or more types of user data from parent application to said application 347. In another embodiment identifying contextual users for particular application from parent user base and synchronizing contextual users' user data including registration, login and profile information, one or more types of contents, and settings from the parent application to the said particular application, wherein identifying contextual users for particular application from parent user base is based on type of application, associated keywords, description, help, use cases, presentation, needs, solution, advantages of application, target criteria, preferences, rules, subscriptions and associated payments including pay per install, pay per user, pay per active user which determined based on number of times usage of application within pre-set duration, frequency of use, user engagement, predefined numbers and types of statistics and analytics with application and human mediated analysis and identification of target userbase. In another embodiment displaying ready to use suggested applications or mini applications or automatically installable applications or mini applications or displaying applications as per rank based on installed applications or mini applications, logged past usage, current location or pre-defined geofence associated identified place, date and time, identified activities based on identified place associated types of activities, user status or updates regarding type of activity, search query, preferences, user profile (age, gender, home and work address, education, school, college, income range, skills, interests, and any combination thereof), suggested by connected users of user, selection, bookmarks, interacted type of entities, logged activities, participations, checked places, transaction details, status and picked by server administrator, current trends, identified updated user data on linked systems, types of installed applications, requirement specification, selected category, type of task(s), one or more types of filter and rank provided by user or rank automatically determined by server based on user engagement and usage pattern, statistics and one or more types of pre-defined analytics with application, reactions including like, comments, bookmark, share, refer, ratings provided by user and connected users of user.

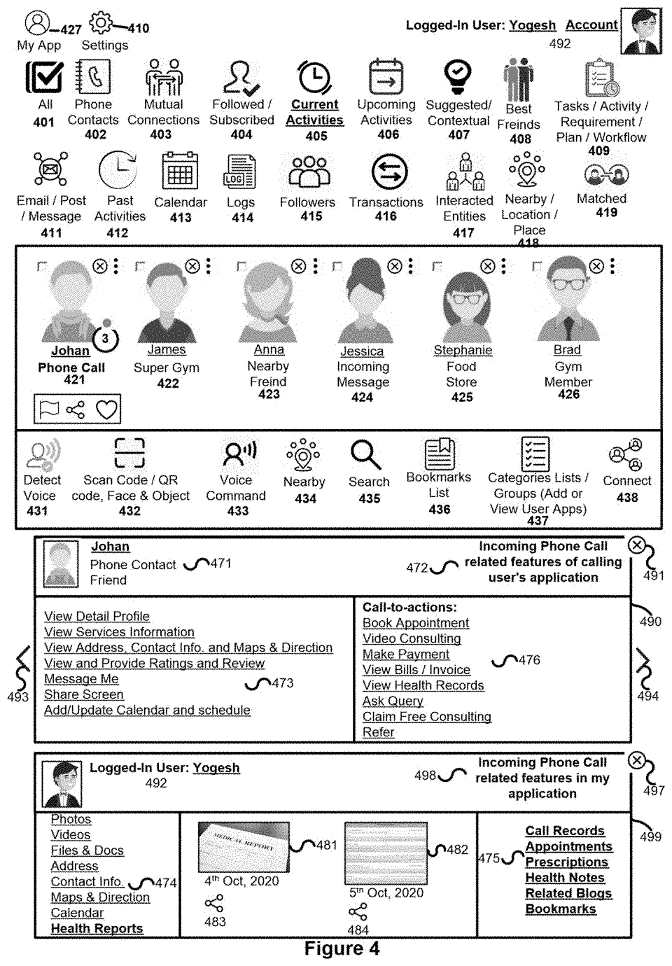

FIG. 4 illustrates graphical user interface where user can access all user added or user related user applications of other users of network including connected, followed, followers, Phone contacts, email contacts, contextual or relevant, interacted and associated users of network. User can view and access all applications 401, view phone contacts associated user applications 402 or phone contacts associated user applications 402 added by user, wherein user can view and access current incoming call associated caller related user application or view frequently called phone number(s) associated applications, view mutually connected users associated user applications 403 including most interacted, most active, most liked, relationships specific, rank wise mutually connected users associated user applications, best friends associated user applications, family members associated user applications, professional connections associated user applications, social network associated user applications, customers or clients or guests or viewers or members or patients associated user applications, sellers or service providers or on-demand service providers or shops staff associated user applications, employee, partners, colleagues, associates associated user applications, followed or subscribed sources or users associated user applications 404 including most reacted on posted contents of followed sources, rank wise followed sources, current activities related user applications 405 including added or categories by user or automatically identified current activities related user applications including identified current location or current location associated place or checked-in place associated contextual user applications, current location or current location associated place or checked-in place associated types of activities or user related type of activity(ies) related contextual user applications, incoming call (phone, voice, video, text call) related user application(s), newly received post, message, updates, location or checked-in place, status related or newly received post, message, updates, location or checked-in place, status in central user interface related user applications, identification of user related or user associated new or updated data or logged information including transaction, status, updates, logged activities, actions, participations, collaboration, sharing, taking of one or more types of call-to-actions or reactions including buy, sell, become member, scan, appointments, bookings, orders, subscriptions, claim or avail offers, participate in group deals from one or more connected or linked or integrated or external or 3^{rd} parties systems, servers, applications, websites, services, databases, platforms, networks, groups, devices, updates from sensors from user devices including digital or smart watch, spectacles, wearables, tablets, personal computers and smart devices, interacted or visited or enter into pre-defined geofence and dwelling for pre-defined period of time or transacted or participated with particular type of or named or location associated entity(ies) including school, college, class, shop, patrol pump, restaurant, hotel, government office and related department, airport, bus station, cab, boat, cruise, railway station, hospital, shop, banquets, chemist, repairs, dispensary, firm, company, office, organization, person including employee, college, partner, associates, classmate, professional, courier boy, commuter, travel group, on-demand service providers, club members, event members (weeding, birthday, anniversary parties) associated user relevant contextual user applications or said entity associated user related activities associated user applications, wherein identifying entity associated user related activities based on past and present status, updates, activity type provided by user or automatically identifying entity associated user related activities based on pre-defined associated types of activities (e.g. sports club then cricket, football, swimming pool, badminton and like and contextual user applications comprises user applications of team members, coach, canteen boy, inside seller and service provider, if restaurant then eating food, ordering, take away, party and contextual user applications comprises user applications of waiter, service provider, manager, security, car parking person, owner, cleaner, chef an like), call-to-actions including buy, sell, become member, scan, appointments, bookings, orders, subscriptions, claim or avail offers, participate in group deals, recognition of voice, scanning of face, body parts, objects, code including QR code, logo, shop, current or checked-in or visited place associated type of activity(ies), and linked or connected integrated or external systems, databases, applications, websites, services, servers, platforms, social networks, e-commerce websites, devices. Current activities may comprises incoming calls, messages, notifications, incoming SMS, calling one or more contacts, sending message(s) to one or more connections or contacts, viewing of television program (identify based on date, time, voice detection), meeting or talking with person(s) (identify based on voice), scan object, face, any scene including photo(s) or text in newspaper, television program or movie or magazine or book (recognize based on object or face or body recognition and optical character recognition (OCR)), current place associated nearby user (identify based on GPS and Bluetooth), currently hearing voice by person, television, radio, music device and like (recognize based on voice recognition techniques), visiting online website, searching, sharing, conducting e-commerce and making payment online (identify based on integration or linking with external domains, websites, applications, social networks, search engines, e-commerce websites, servers, databases, network, platforms and devices via web services, APIs and SDKs), calendar entries, pre-set alarms, current date and time associated events.

For example, when user [Yogesh] 392 visit and attend school [ABC] class [10^{th}] then display user applications of teacher, class students or selected or bookmarked or automatically determined related users and connect user application of user [Yogesh] 392 with said user applications based on privacy settings, rules, access rights and policies and preferences. User [Yogesh] can ask teacher query, note answer, show home works, participate in event or tour and make payment, participate as volunteer, make complaint of other students, view questions of teacher, clarify questions, provide vote, raise hand, contribute money, connect with parents and converse, clarify, make payment, hear complaints of other student and like, participate in group deals or group buying or purchase books, uniform, stationery, project items and accessories, participate in sports or event (dance, music, play, host and like). In another example when user [Yogesh] 392 visit college [PQR] lab then display user [Yogesh] project related participated students' user applications to each participated member based on privacy settings, rules, access rights and policies and preferences. User can collaborate with lab staff, other members and staff, manage and divide tasks, workflow, status of project, show project, clarify, ask question and view answers. In another example when user [Yogesh] 392 visit restaurant [VegSuper] and make order then connect user [Yogesh]'s user application with and display to user [Yogesh] user applications of hotel staff (waiter, admin, chef, owner and related other staff) and nearby connected users. In another example when user [Yogesh] 392 visit Gym [Super] then connect user [Yogesh]'s user application with and display to user [Yogesh] user applications of known gym members, staff of gym. User can bookmark, add, follow, connect with user applications. In another example when user [Yogesh] 392 visit cloth store [Hilfiger, Viviana] and buy clothes from shop then in the event of conducting of transaction automatically add user application of sells person or other staffs with designation (tailor, admin, other customers). User can view bills, invoice, and can share cloth sizes and measurements with shop staff, ask query, view new stocks, make complaint, claim offer, redeem points, share home address for delivery, view schedule for custom fits, return cloths. In another example when user [Yogesh] 392 visit sports club [Prime] then connect user [Yogesh]'s user application with and display to user [Yogesh] user applications of team members, fans or viewers, coaches, club members, and club staffs. User can view schedules of sports, make contribution, get wining prize, communicate with coach, share photos with team members and fans or viewers, make notes. In another example when user [Yogesh] 392 visit Hotel [Taj, Mumbai] then connect user [Yogesh]'s user application with and display to user [Yogesh] user applications of hotel room related staffs and other general staffs and internal and external service providers. User can share preferences and requirements about room, food, required services, book and schedule cabs, guides, purchase products, give tips, order food, laundry service, provide reactions including comments, like, dislike, participate in survey. In another example when user [Yogesh] 392 visit Airport [Los Angeles Airport] then connect user [Yogesh]'s user application with and display to user [Yogesh] user applications of related airport staff for assistance, queries and view schedule of flight, shops to claim custom offers from shops, negotiate, advertise requirement among shops of airport and search required and available products, restaurants to order foods, share required documents. In another example when user [Yogesh] 392 visit event [Birthday Party] of contact person then in the event of reaching at location or location associated place or entered into pre-defined geofence associate with event, identifying nearby contacts of user at event and enabling contacts to collaboratively take and share picture of event and save captured visual media to event related album with location, place, date and time and event details or event related nearby contacts can individually take visual media and can select nearby user applications and share captured or selected visual media and real-time provide reactions. Contacts can in group present reactions or gift or cash gift. In another example when user [Yogesh] 392 can click or tap on connected user's application 307 and can view upcoming events, posts posted by connected user 322, access other features including my today's menu live cooking and recipe feature, my articles, my home business, open for schedule meeting at particular date and time for conversation and like. In another example when user [Yogesh] 392 dwell for pre-define duration in location or pre-defined geofence associated with home, displaying family members related applications and enable to view activities, transactions, liked and purchased products and services, assign and monitor and track task, view notes, discuss on various topics, makes notes, share photos, discuss on expenses or bills, collaboratively select today's menu, collaboratively decide and make order and payment, collaboratively decide and book ticket or articulate travel plan. In another example when user [Yogesh] 392 dwell for pre-define duration in society or pre-defined geofence associated with society, dynamically create group related to participants of current society event or festival or program and enable to collaboratively vote for particular issue or project or task, contribute payment or resources, select menu, make and resolve complaint, provide suggestions, provide reactions on contributors work, decide next event plan and activities and like. In another example when user [Yogesh] 392 dwells for pre-define duration in office or pre-defined geofence associated with office, display nearby employees or members or colleagues and enable to select user application of particular user and view associated task or assignment status, complaint, posted photos or files, updated profile, suggestions, expenses, queries, requests.

In another embodiment user can view user applications related to upcoming activities 406 including events, scheduled meetings, boked tickets, appointments, calendar entries, alarms, festival events related to particular date and time, assigned tasks, updated news, events, status.

In another embodiment user can view updated suggested or contextual user applications related to user 407 based on user profile, connections, user application or user profile visited users, logged digital and physical activities, participated events, visited places, liked posts, products, persons, transactions, status, requirement specifications, updated data from integrated external domains or linked systems and devices.

In another embodiment user can view user applications related to best friends 408. User can mark selected contacts or connections as best friends and family or relatives.

In another embodiment user can view user applications related to particular type of task, activity, requirement, plan, project, workflow, keyword, category, location, product, brand, company and any combination thereof 409. In another embodiment user can open user's own application 427/304 and due to admin rights user can view as well as post, update, one or more types of contents, profiles, payment information, invite to connect or accept connection request, unfollow, remove, view logs, history, bookmarks, post status, location information and logs, apply access rights, policies, privacy settings to allow other selected users to view, access, add, update, remove, post one or more parts of application including contents, mini applications, connections, logs, payment information, profilers and like.

In another embodiment user 492 can view user applications related to incoming email and email message or content related persons or one or more types of entities related user application 411. For example, display user actions related to various types of email messages including offer, deals, new stock message, notification, status, scheduled meeting or calendar entries, reminder, appointment, pending payment or bill, updates, news,

In another embodiment user 492 can view calendar entries associated user applications 413, wherein identifying calendar entries associated user applications based on identifying connected or integrated calendar entries associated entities including meeting persons, visits at particular place(s), reminder of making payment, scheduled meetings, booked tickets, attended events, hosted events, festival, holiday related planned activities, planned tasks, work, workflows related members.

In another embodiment user 492 can view user applications related to logged activities of user and connected or interacted or related user of user 414, wherein logged activities comprise presently at home (with family members), viewed particular television program (identify based on date, time, home location, recognizing scanned photo sent by user or user status or updates e.g. “I am watching Kapil Sharma”), visited neighbors, friends, relatives, on-demand service providers, society staff, home workers (identify dwelling duration at particular location e.g. home), attended society events e.g. sports, festival, group buying (identify society participated members), visited at club or garden or gym (view identified members, staff, in contacts), visited shop (view identified similar customers, shop admin and staff), booked events (identify event associated members), traveled via cab, eat food at particular restaurant, stayed at particular hotel, visits particular tourist place, attended college lecture, attended particular event at college, attended particular meetings with particular persons, sell products to particular customers, provide services to particular clients or subscribers, attended office or work place and identify associated user applications. User can view present and past logged activities and associated user applications and can open or access, add to one or more lists, follow, and connect with selected user applications associated users.

In another embodiment user 492 can view user applications related to user followers 415.

In another embodiment user 492 can view transactions associated user applications 416, wherein identifying transactions associated entities associated user applications based on online order, purchase, participate in group deals, claim offer, redeem points or offers, take one or more types of call-to-actions including buy, subscribe, become member, get free offer, book tickets, donate, send bill or invoice or receipt, send or receive or contribute money, order, schedule on-demand service, add to cart, get appointment, and make online full or partial payments, make payments for salary, make payment for subscription, wherein identifying transactions and transactions associated entities details from linked or connected or integrated websites, applications, services via APIs, offline payment (identify based on user status, user notes, user input, voice command, scanned bill or invoice, identified sent receipt via email or SMS or notification or message) to identify associated or contextual user applications.

In another embodiment user 492 can view interacted entities associated contextual user applications 417 wherein identify user 492 interaction with entities based on identification of transaction, with particular entity, call-to-action(s) associated with particular entity, visited or visiting particular place or location associated entity, scheduled meetings with one or more persons, purchased products related seller, distributor, supplier, manufacturer or company or brand, airport staff, current tour guide, current cab driver, nearby travelers, purchased or ordered online products associated entities, pre-defined rules, roles at particular named, type, place or location associated entity (seller, buyer, teacher student, classmate, contact, member, service provider, service consumer, guests, hotel staff, shop staff, clients, patients, viewers, traveler, government employee having particular designation, neighbor, family, friend, associates, partner, employer, manager, administrator, security, cleaner, waiter, chef, delivery boy, cab driver, rider, visitor, payment counter person, assistant, home worker, consultant, doctor, lawyer) and based on types of interacted person associated pre-defined selected persons display user applications i.e. different types of persons interaction with different entities may cause to different types of persons related user applications For example if student visit or attend class then display class related students and current teacher, But if teacher visit school then display current class associated students and other relent teachers and staff members, principal, trustee and like.

In another embodiment user 492 can view nearby user applications including nearby bookmarked user applications, user's contacts related nearby user applications, staff or place related user applications, nearby classmates and teacher(s), nearby users based on user provided matchmaking criteria, search query, rules, location or activity specific preferences and privacy settings, detection of voice, providing voice command, scanning object, logo, scene, human face, body, detection of RFID tags or other types of tags, digital activities, location or place associated contextual users including neighbors, society staff, home workers, on-demand service providers at home or office, currently nearby friends and family members, colleagues, staff, project members, employees, department specific staff or pre-defined or identified related persons, nearby delivery person, shop staff, person at nearby pump(s), pre-defined person(s) at religious place, cab driver (user can view photo, cab number and make payment), payment counter staff (user can select current payment counter person related user application based on number and make payment, current event place associated identified nearby relatives user applications, nearby friends of friends or contacts of contacts, nearby similar interest or matched user applications, nearby viewers, nearby customers or clients or guests, or members or subscribers or attendees or patients, nearby travelers or commuters (dynamically create group and collaboratively take and share photo), nearby similar or matched types of patients (ask queries, experience, ask about doctor, fees or charges, ratings, reviews and staff and facilities) and updated nearby users applications, wherein identifying nearby user applications based on users devices locations, checked-in places, identifying nearby Bluetooth devices, identification of pre-defined geofence, dwelling for pre-defined duration at particular place. User can open or select and add, follow, connect nearby user applications. User can view nearby users in categories list, wherein list comprises in contacts, in staff, my employees or staff, family members, best friends, friends of friends, similar including same school, college, class, year or standard, same destination, same order, same particular club member, similar company, organization, firm, native place, and any combination thereof, project member, partners, colleagues, associates, co-workers, classmates, customers, clients, guests, members, patients, employees and like.

In another embodiment user 492 can view matched user applications 419, wherein matchmaking take place based on one or more matchmaking criteria provided by user or automatically identified or matched by system based on user preferences, interests, privacy settings, user related data including matching similar interests, user profiles, logged users activities, actions, participations, transactions, communication, collaboration, sharing, status, updates, locations, digital activities on external domains or linked or integrated system identified via web services, APIs and SDKs and associated mini applications and matchmaking rules.

In another embodiment user application or group(s) of user applications associated with one or more types of entities including person, group of persons, brand related persons, predefined group(s) related persons, shop related staffs, school, college, company employees, service providers, automated agent, organization.

In another embodiment user can identify nearby person based on recognition of user 492 or user device(s) 200 surround voice, conversation and sound 431 based on employing one or more voice recognition techniques, wherein matching recorded voice or sound or conversation with pre-recorded voice of users of network and identifying identity of matched user(s) and identify associated user application(s). User can click or tap on “Detect voice” 431 or user can set continuously detect voice settings to continuously monitor, track, record, and recognize voice and identify associated persons or users and identify associated user applications.

In another embodiment user can click or tap on scan 432 to scan or take photo or video or raw photo(s) of scanned code including QR code, logo, face, body parts, objects and scene and send to server for recognizing scanned code including QR code, logo, face, body parts, objects and scene associated users of network and identifying associated user applications.

In another embodiment user can click or tap on voice command 433 or based on settings user can enable voice command to continuously monitor, track, record and identify or recognize voice command and act based on voice command(s), wherein voice commands comprises detect voice, scan, view nearby, search, and select user applications, open, add to list, follow, and connect user applications, make call, take photo, record video, share contents to one or more user applications, block, remove, show, hide, unfollow, send invitation to connect, accept or reject connection request, apply do not disturb settings.

In another embodiment user can click or tap on view nearby user applications 434.

In another embodiment user can enter or select keywords or search query and click or tap on search 435 to search user and user applications.

In another embodiment user can click or tap on bookmarked list 436 to view and select list item(s) and can open, add, follow, connect with user application(s).

In another embodiment user can click or tap on categories lists and groups 437 to view and select list item(s) and can open, remove, unfollow, rank, order, re-categories or add to other category(ies) or list(s) added user application(s), wherein user can create list and add selected user application(s) to selected one or more lists, wherein list may comprises my family, best friends, college friends, school friends, class friends, neighbors, vegetable suppliers, doctors, medicine stores, shops, purchased products, subscribed services, task specific, activity specific, location or place or brand or company or organization or entity name specific.

In an embodiment user can click or tap on particular user application icon or name or image or control or uniform resource locator (URL) 421 to open user application 490. User can switch user applications by tapping or clicking on preferred tab of user application or icon or name or image or control or uniform resource locator (URL) of user application 422 or 423 or 424 or again 421. In an embodiment user can close 491 user application. In an embodiment user can user can tap or click on previous 493 or next 494 icons to open previous user application or next user application.

For example when user 492 clicked or tapped on particular user application icon or name or image or control or uniform resource locator (URL) 421 then open or invoke or execute said clicked or tapped user application icon or name or image or control or uniform resource locator (URL) 421 associated user application or user mini application within parent application or user applications app store application 300/400 installed in user device 200 and logged in by user e.g. user [Yogesh] 492.

In another embodiment automatically opening user application(s) based on triggering of events, rules, and identification of executing of one or more types of pre-defined triggers, wherein trigger comprises identification of nearby (within predefined radius) pre-defined geofence, entering in particular pre-defined geofence, entering in particular pre-defined geofence and dwelling for particular duration, pre-set alarms at particular data and time, scheduled date and time, calendar entries, incoming call including phone call, outgoing call including phone call, incoming email or message or notification or post, identification of predefined nearby contact(s) or location or place or pre-defined geofence associated pre-defined relevant users including server, staff person, courier person, home worker, project member(s), predefined date and time including festival, event date, recognition of scanned photo, detection of voice, recognition of voice command, receiving status or updates or checked-in place or location information of contacts, recognition of particular type of activity or action or event or transaction or communication or sharing or collaboration, receiving status task related to user from one or more other users, interpretation of user status and identify user(s) and based on triggering of triggers open associated user application.

In another embodiment automatically closing user application based on identification or triggering of pre-defined triggers including exiting from particular pre-defined geofence, ending of call including phone call, tap or click on close icon,

In another embodiment automatically identifying trigger, place, location, pre-defined geofence, date, time, relationship, roles associated application features, mini application, contents and data and allow to access said features, mini application, contents and data as per permissions, rules, access rights & policies and privacy settings of user associated with user application.

For example in the event of receiving by user 492, incoming phone call from user [John], automatically open user application 499 of user [Yogesh] 492 and automatically identify user [John] based on phone number and automatically open identified user [John] associated user application 490 and enabling user [Yogesh] 492 to share data or content 481/482 or home address and maps & direction 474 from user application 499 of user [Yogesh] 409 to said calling users' user application 490, take one or more call-to-actions 476 including ask query, book appointments, share details, make payment, get video consulting, view address, information and contents 473 and like. User [Yogesh [492 can record calls, save appointments, share prescription, note down notes, view blogs related to particular issue, view bookmarks and like.

In an embodiment integration-able or linkable mini applications with user application may comprises content preparation and management, editor, photo or video augmentation tools, filters and effects, stickers, language dictionaries, keyboards, spell checker, and templates, readymade one or more types of contents, calendar, project, task, assignment, workflow management, alarms, webpage or website generator, menu and products and services catalogues and management, event management, e-commerce, communication, sharing, collaboration including collaborative order, payment, vote, decision, planning, task, workflow, activities, actions, participations, and reactions, expense management, health management, travel management, time and activities management, various types of call-to-actions for users of user application including buy, order, book, participate in deals, check-in for enabling user to manage all ser generated contents (UGC), shared contents from other users, bookmarks, URLs, logged activities, and multiple profiles, and enable to share, communication, feedback, complaint, collaboration, offer or avail services, play game, plan, schedule, take call-to-actions, manage prescription, health reports, access tips and tricks, questions and answers, take decision to buy, recommend, prepare requirement specification including grocery, medicines, order, book appointment.

In another embodiment user can store central copy of all user generated contents (UGC), different types of profiles, connections, settings, preferences, logs, activities, calendar and share one or more types of contents to one or more connections or followers or one or more selected external domains

In another user can store personal contents and data including personal notes and contents, health reports, sensitive information including passwords, payment information, secure messages, calendar and plan, contact information and profile.

In another user can use user application for multiple purposes including for public or users of networks including sharing, publishing, offer products and services, for customers, clients, guests, employees, partners, relatives, friends, followers, viewers, listeners, attendees, patients, for connected users (family and best friends) including sharing, status, updates, collaboration, communication, payments, activities and for personal or private including appointments, bookmarks, likes, bookings, calendar, schedules, purchase of products and services as per settings and rules.

In another embodiment identifying current place associated type of activity(ies) and associated users' user application (e.g. If Gym then activity is exercise and associated staff, if sports club then activities is/are sports or identify particular sports based on user profile, user updates or status or logged activities and identify members, if airport then shopping and eating food and associated staff, waiter, seller, a manger, admin, security staff, if particular type of shop then shopping particular type of products, if restaurant then eating food including favorite, ordered, menu, if movie theatre then watching current movie, if chemist then medicine provider, if dispensary then doctor) and like.

In another embodiment user can bookmark current place or interacted entity and associated user application for later use or display for same activity at same location.

By using user application user can create user base from parent application and independently, offer more features than provided by parent application or network, integrate or link mini applications and call-to-actions for creating or grow or engage userbase. User can customize look and feel of user application including color, background, wall papers, font, emoticons, stickers, ringtone, icons, images, animations.

In an embodiment user can subscribe cloud storage and use user application for storing, publishing, sharing, sharing link, viewing, updating and managing user generated and user related one or more types of contents. In another embodiment user can upgrade or subscribe user application generator application for generating more and enhanced features and adding updated or upgraded or enhanced version with more services mini applications with user application. In another embodiment user can search, match, select and book, subscribe and make payment for unique user name or domain name for name of user application within user application store or platform or network. In an embodiment user can select premium user verification services for verifying user and provide verification badge(s). In another embodiment enabling user to opt ranking service to get ranking of user and associated badge(s), wherein ranking is based on verifying user name, fame, number of followers, viewers, posts and reactions on posts on one or more external social media application or social network or other applications. In another embodiment enabling user to select one or more paid mini applications and make payment to customize, add, integrate or link with user application. In another embodiment charge user for listing or listing in prominent place user application on user application store. In another embodiment enabling user application associated user to monetize user application by displaying one or more advertisements and associated call-to-actions verify, published and listed by user application store in user application and share advertisement revenue based on number of views, clicks and call-to-actions. In another embodiment enabling user to select type of user application, type of domain or category or get details from user about what type of application user want to create or generate including e-commerce (sell, booking, appointment, deals, reservation), teaching, content, travel, cloth, health, professional (doctor, lawyer), type of business (cloth shop, patrol pump, restaurant, travel, hotel), location or address, age, gender, education, skills, company name, designation or position, income range, want to offer services (content drafting, design, profile writing and like), interests, liked activities, connected users, type of followers and based on these information display templates, wizards and selection and generate or create user application. In another embodiment enabling user application to connect other user applications or enabling user application to other one or more user applications communications, collaborations, sharing based on user application associated user's permission and privacy settings. In another embodiment enabling user application to automatically communicate with other user application(s) based on rules, triggers and artificial agents for answering question, making payment, claiming offer, getting ask, updating status, participating meeting, scheduling meeting, negotiation, sharing one or more types of content including address, maps & direction, user full or partial or business or professional profile, make call, send message, send email, make order, request one or more types of on demand services, send notification, send instruction, offer service, ask query, accept connection request, refer, suggest, ask for bill or invoice, ask waiting time, and open user application based on triggers. In another embodiment enabling external domains or applications or websites databases or servers to share user related data with user application and enabling user application to share said data with other one or more types of applications including user applications, mini applications and external applications. In another embodiment enable external applications to develop, create, submit, verify, make searchable, publish and list mini application version of said application and enable user to select and add, integrate, link, display one or more mini applications of extremal applications with user application for enabling user or users of user application to share contents, book, order, buy, participate in deal, get appointments, send message, email, make call and like. In an embodiment enabling one or more types of entities including shops, malls, brands, companies, firms organizations, clubs, patrol pumps, schools, colleges, government agencies to develop, create, generate, upload, submit, register, verify, list, publish, make searchable user applications or applications or mini applications which are connected with user applications, parent application or user application store and can integrate with user application or parent application or user application store to enable user or user application to application of one or more types of entities communication, transaction, interaction, collaboration, and sharing.

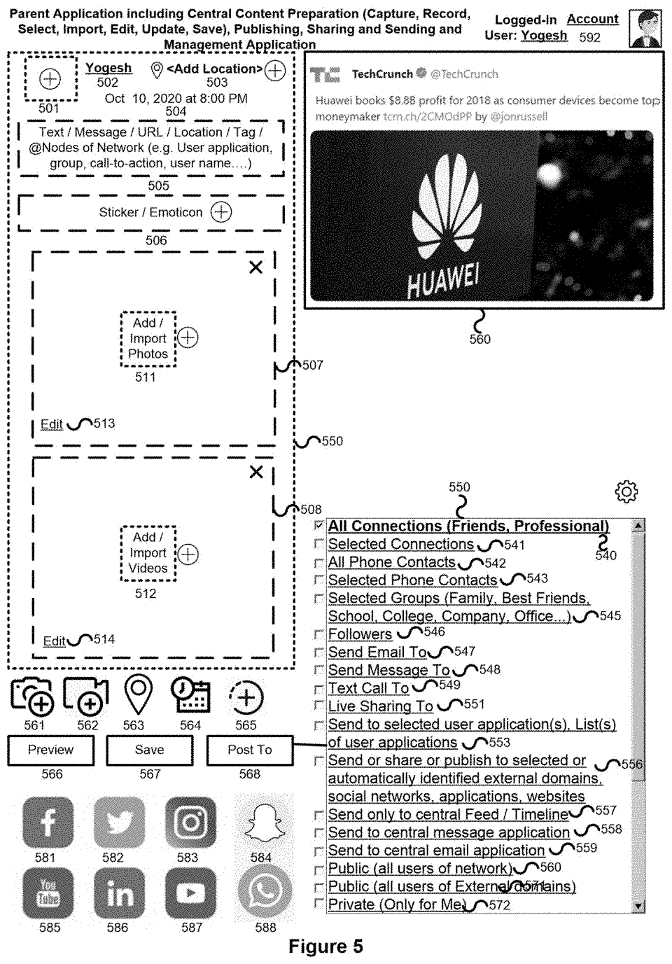

FIG. 5 illustrates graphical user interface or application provided by parent application or user applications store application or platform or server for enabling user [Yogesh] 592 to central content preparation, publishing, sharing and sending and management application to capture, record 562, select 507, import, edit & update 507/508, preview 566, save 567 one or more types of contents including post, ephemeral post or story, captured or selected photo(s) 561, recorded or selected video(s), message, tweet, blog, article, short video 550/560. Within single user interface user can draft, edit, augment message, tweet, post, ephemeral story, photo, video, short video. User can apply one or more filters, overlay text, add or mix music with short video, add or select location 503/563, uniform resource locator (URL), tags, keywords 505, stickers, emoticons, emojis 506. Use can add 511, select 511, import 511, capture 561 one or more photos 511, add 512, select 512, import 512, record 562 one or more videos 512. User can save 567 contents and can preview 566 contents 560. User can schedule 564 posting of contents. User can send, publish, share and post contents to all mutual connections of user or all connections of social networks (Friends) or all connections of professional network 540, selected connections 541, all phone contacts 542, selected phone contacts 543, selected groups including Family, Best Friends, School Friends, College Friends, Company, Employees, Students, Customer, and Office Group 545, Followers 546, Send said content as email to selected email addresses or group(s) or users 547, Send said content as Message to selected contacts 548, make Text Call and send said content to selected contacts 549, schedule or start Live Sharing and invite or call or notify to view or receive live or real-time sharing of contents to selected contacts 551, Send said content to selected user application(s), List(s) of user applications 553, Send or share or publish said content to selected or automatically identified external domains, social networks, applications, websites 556 including Facebook (Post/Story/Message) 581, Instagram (Photo/Story), Twitter (Tweet/Message) 582, Snapchat (Story/Message) 584, YouTube (Video) 585, TikTok (Short Video) 587, LinkedIn (Professionals related Post) 586, Gmail (Email), WhatsApp (Contents/Message) 588 and one or more other external applications via APIs and SDKs or sharing controls, Send said content only to central Feed/Timeline user interface 557 of parent application or user applications store application, Send said content to central message application 558 of parent application or user applications store application, Send said content to central email application 559, Send said content to all users of network (Public) 560 and/or Send said content to all users of external domains 571, save said content as private and accessible only for user 572, wherein receiving user can view said posted contents on central feed application and/or email application and/or message application and/or respective user application and/or selected applications, websites, servers, databases of external domain(s) including Twitter, Facebook, YouTube, Gmail, Instagram, TikTok, Snapchat, regional or local language social networks.

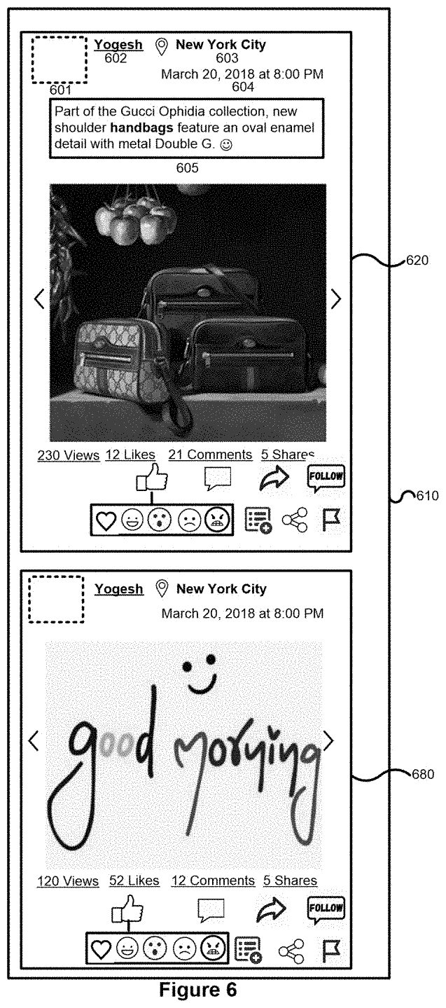

FIG. 6 illustrates graphical user interface (GUI) of parent application or user applications store application wherein logged-in user can view received new items or posts or messages from other users of network including connected users, contacts, followed sources, and interest or automatically determined or suggested or contextual or matched public contents from users of network.

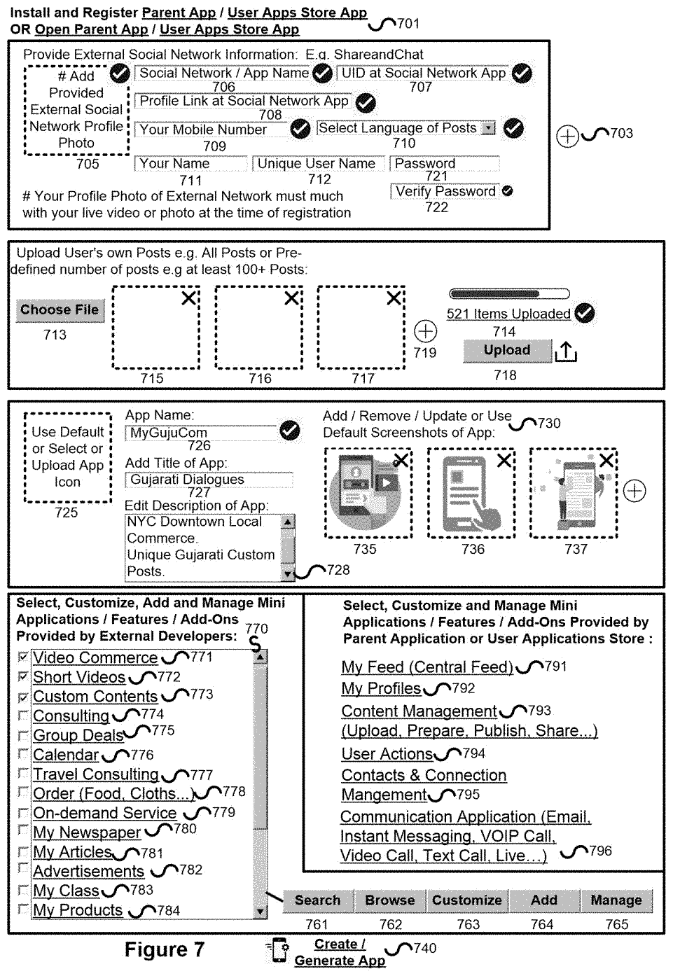

FIG. 7 illustrates in one embodiment verify user based on matching live photo of user with profile photo of user on one or more external domains and identify user's rank, weight, number of followers, viewers, type and numbers of reactions including likes, dislikes and different types of emoticons, comments, shares, replies, mentions and views. In another embodiment user can upload user generated contents created, owned, possessed and related to user from local user device(s) or from one or more external domains, applications, cloud storage, databases, devices, websites, social networks, profile, servers, network, platform.

In another embodiment's user can upload or add or select profile photo of external domain 705. Server module matches said received user profile photo with received user photo or images inside received video depicting user face and/or body and in the event of matching of user profile photo with said live photo or image(s) inside live video of user, enabling user to provide associated details including application or website or social network name 706, unique user identity 707 at said application or website or social network name 706, user profile uniform resource locator (URL) or link 708 at said application or website or social network name 708, mobile phone number 709, and optionally can select language of post 710, name of user 711, user name 712 and user password 721/722. Server verify user mobile device via sending one-time password (OTP) on user provided said mobile number associated user smartphone and enable user to manually enter OTP or automatically enter and verify OTP. In another embodiment user can add 703 or upload details, data and content related to one or more external domains, servers, databases, applications and websites. In one embodiment user can select one or more types of one or more content items including posts, photos, videos, messages, tweets, short video, blog, article, micro blog, album, user profile and any types of user generated or user related contents 713. In an embodiment after selection of contents user can view, edit, update, augment selected contents and can remove selected contents 715/716/717. User can select and add more contents 719. User can upload said selected contents by tapping or clicking on “Upload” button or control 718. In another embodiment in the event of selection of content 713 automatically upload content. In another embodiment progressively upload content from user client device to sever. In another embodiment queuing content for upload in user client device and in background upload content as and when server resource available or as per server instruction. In another embodiment after selecting content and tapping or clicking on “Upload” button or control 718 if non-availability of internet data connection or any other user client device side problem in uploading contents then retry upload later when user client device is ready for upload content.

In an embodiment server module matches said uploaded user profile photo 705 with said user profile uniform resource locator (URL) or link 708 associated extracted user profile photo and also matches live user photo from user client device to said uploaded user profile photo 705 and/or said extracted photo to identify and verify user. In another embodiment server module verifies user provided user identity of external network 707 with said user profile uniform resource locator (URL) or link 708 associated extracted user identity. In another embodiment server module recognize language of uploaded post or content by employing object or language recognition techniques and optical character recognition (OCR) techniques. In an embodiment server module checks whether user uploaded content items as per predefined rules to identify eligibility of offer, wherein predefined rules comprise number of photos, number of videos, number of posts, number of message or microblog and like.

In another embodiment based on user provided details 706/707/708 of external domain, server module automatically or manually identifies number of followers, number of posts posted by users, number of messages or micro blogs or photos or short videos or videos or contents, number of views, types and numbers of reactions including like, dislike, comments, shares. In another embodiment based on user provided details 706/707/708 of external domain, server module automatically or manually identifies number of followers, number of posts posted by users, number of messages or micro blogs or photos or short videos or videos or contents, number of views, types and numbers of reactions including like, dislike, comments, shares to identify one or more types of eligibility as per rules, criteria including and enable user to get or claim one or more types of offers including become registered member of particular application and generate user application and enable to synchronize including snapshot and merge push synchronization of one or more types of information and data including records or data of followers, connected users, viewers on offeror application to user application. So, with permission of following users, followers on said offeror application become registered user of said user application.

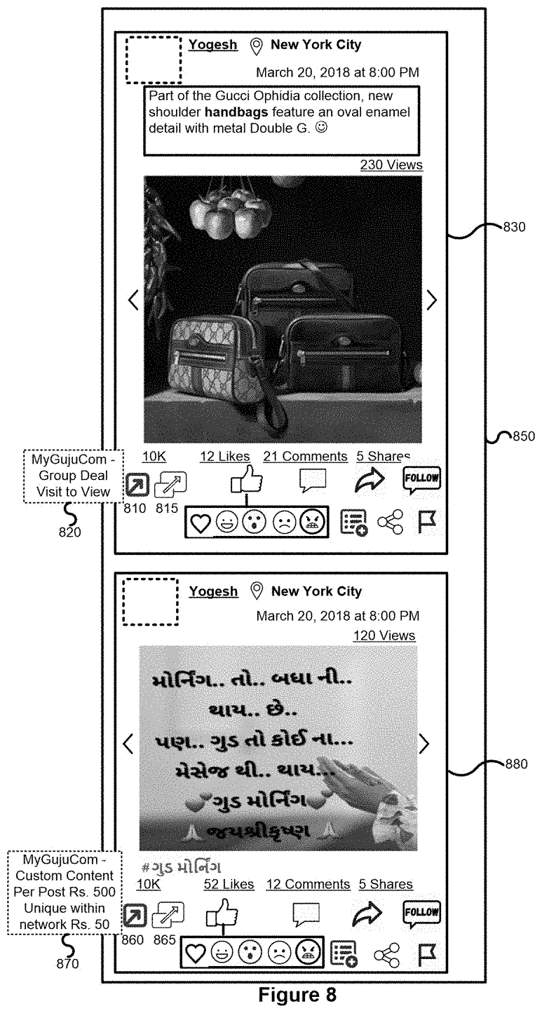

In an embodiment based on user permission, synchronize parent application related user's data/content (e.g. FIG. 8—830/880) with connected user application 930 from module 283 of user client device 200 via server 110 module 162.

In another embodiment enabling user to upload user generated and related contents and identifying contents as per requirements, complaisance and rules including contents does not contains duplicate contents, inappropriate contents and related to particular language contents via manually or by employing object and language recognition techniques and optical character recognition (OCR) and determining eligibility of user to provide one or more types of offers based on rules and policies.

In another embodiment after identifying eligibility by installing and register with particular application, providing one or more types of required information, uploading contents a per rules and/or rank and/or one or more other eligibility criteria, enabling user to generate user application. User can provide or select or use default application icon 725, application name 726, title of appellation 727, description of application 728, add or update or remove application screenshots 735/736/737. After providing details, user can generate user application by tapping or clicking on “Generate Application” icon or control 740.

In another embodiment after providing one or more types of required information, enabling user to generate user application. User can provide or select or use default application icon 725, application name 726, title of appellation 727, description of application 728, add or update or remove application screenshots 735/736/737. After providing details, user can generate user application by tapping or clicking on “Generate Application” icon or control 740.

In an embodiment generate and provide Android, iOS and Web full source code of generated application and upload and publish generated application on Google Play Store/Apple App Store/web application/mini application, provide limited storage, provide unique available domain name/application name for pe-defined duration, verify user and provide badge and rank badge, provide support for generated application, provide updates for generated application, synchronize userbase including followers, connected users and viewers data from parent application to the generated application, provide mini applications and services (displaying ads, ads of ad network, paid contents (custom or ready) and e-commerce and like) for monetization of generated application and associated userbase, provide different types of presentations, templates, icons, contents, emoticons, stickers, backgrounds, splash screen, and selected unique icon for application and logo.

In an embodiment enable user to select and customize default features including customize or configure news feed or my feed or timeline feature or application or graphical user interface (GUI) 791 including select type of presentation, font, color, size, look and feel, apply privacy settings and access rights and policies for user application content access for other one or more types of user of networks. In another embodiment enabling user to customize one or more types of ser profiles including general profile, social profile, health profile, travel profile, job profile, professional profile, matrimonial profile and other types of profiles, wherein customization of user profile comprises add, remove, update one or more fields and associated one or more types of values, look and fill of profile. User can fill or update user profile details or data. In another embodiment user can customize content management application and upload or edit already exists or created or related user generated contents. In an embodiment user can first prepare one or more types of user generated contents within user application developed, created, generated, owned, associated by/with user and then user can post or share or publish or send said one or more types of user generated contents on selected one or more external domains, applications, websites via their application program interface (APIs) and software development toolkit (SDKs) or allow external domains, applications, websites to pull user authorized data and content from user application.

In an embodiment enabling user to import phone contacts 795 for enabling server module to identify mutual connections with other users of networks, based on social network accounts and APIs importing and identifying user connections, followers of external domains to present domain or parent application or user applications store application or network.

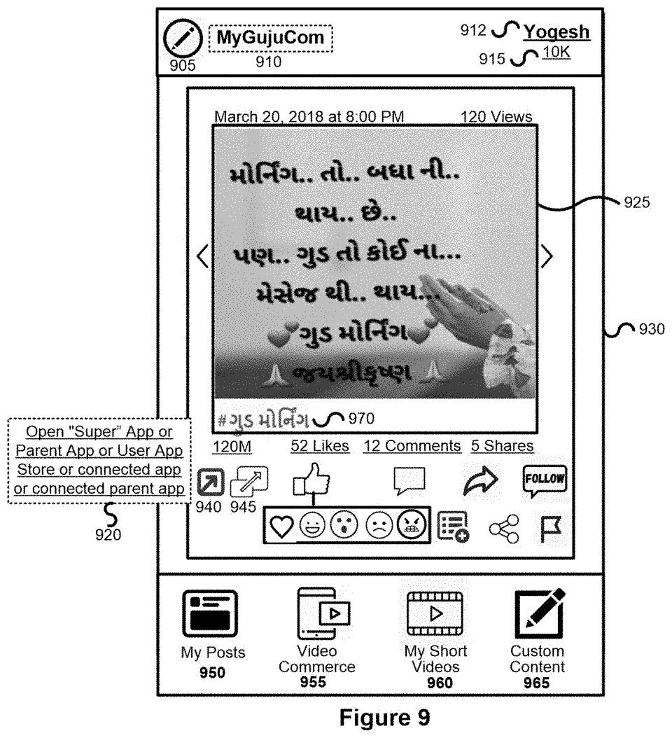

In another embodiment enabling 3^{rd} parties developers to register and verify with the user applications store as developer and enable to register, upload, update, verify, publish and make searchable for other users of network one or more mini applications or sub-application which open within or from parent application or user applications store without user need to download, install, register, log-in, update, uninstall or reinstall user application. User can search 761, browse 762, match, select from one or more types of lists including select from suggested list 770 one or more mini-applications or select 771/772/773 and customize 763 one or more mini-applications and add or integrate 764 with user application (describe in detail in FIG. 9). User can manage 765 including upgrade, rank, order, remove, customize added or integrated mini applications with the user application.

In another embodiment enabling 3^{rd} parties' developers to register and verify with the user applications store as developer and enable to register, upload, update, verify, publish and make searchable for other users of network one or more smart client applications or applications.

In the event of receiving instruction to generate user application, server module generates user application based on user provided data, content, settings and one or more types of verification. In various embodiments server module generates mini applications which other users or other authorized users can directly access within parent application or user applications store application without user need to download, install, register, log-in, update, uninstall or reinstall user application, generates Android application which can publish on Google Play Store and install or run on android devices, generates iOS application which can publish on Apple Application Store and install or run on iOS devices, generates web application which run in web browsers.

FIGS. 8-9 illustrates newsfeed or central feed of timeline user interface of parent application or users' applications store application and published associated integrated or linked use application in one embodiment, wherein user can view posted or shared or published or sent or received one or more types of contents. In another embodiment user can view integrated 810 user application in the form of mini application which viewing user can click or tap and open without user need to download, install, register and log-in (parent application or user applications store log-in information utilized for user application) or linked 615 user application in the form of installable or installed application of content posting user or publisher or source. For example, viewing user [A] can view received posts 830/880 from connected users and followed sources in central newsfeed or feed or timeline application of graphical user interface (GUI) 850. In an embodiment User [A] can click or tap on post 830/880 associated integrated user application icon 810 to open integrated user application FIG. 9 (930) in the form of mini application. In another embodiment User [A] can click or tap on post 830/880 associated linked user application icon 815 to open installed or installable user application FIG. 9 (930) in the form of smart client application FIG. 9 (930) (e.g. Android and iOS application which user need to install or can open already installed application via link or uniform resource locator (URL) 815 of application).

In an embodiment based on privacy settings and presentation settings, viewing user can view accessible link or icon or control of user application of publisher within parent application or super application or user application store application, in central newsfeed or feed or timeline, in central communication application, in post or posted or sent or shared one or more types of contents or message, within user profile, in message, in the form of uniform resource locator (URL), in one or more types of lists including suggested user applications or directories, in another user application to access user application of publisher.

FIG. 9 illustrates example user application. In an embodiment user can open user application 930 within parent application or user applications store application or feature of parent application or user applications store application 850 or viewing user can independently open user application from application stores including Google Play Store or Apple App Store. In an embodiment viewing user can view posted contents within central feed interface of parent application or user applications store application as well as in user application of publisher or particular user and can access other features 955/960/965 of ser application 930. In another embodiment user can click or tap on integrated parent application or super application or user application store application icon 940 (if user application is in the form of mini application) or user can click or tap on link or uniform resource locator (URL) of parent application or super application or user application store application 945 (if user application is in the form of smart client application or installable or installed application e.g. Android or iOS application).

In another embodiment allowing only eligible users and user associated application to connect with parent application, network, server(s) and database(s) and enabling users of parent network to follow or connect or send invitation to connect one or more selected eligible users or associated applications connected with the parent application. Except eligible users, other users of network do not allow to post one or more types of contents or allow others users of network to follow non-eligible users or other users of network. Other users of network can follow eligible users and view posted contents from eligible followed sources or applications. For example, eligible applications of celebrities connect with parent application or network and enable users of parent network to follow said eligible celebrities and view posted on or more types of contents including micro blog, photos, videos, posts, stories, short videos and messages from said celebrity associated application to follower's central feed user interface of parent application. In another embodiment eligible users can prepare and post one or more types of contents and posts content preparation from user interface of parent application. In another embodiment enable user to follow other users of network based on searching of profiles including user names or user identities of users of network and tapping or clicking on search result item associated embedded or integrated or presented follow button or icon or link or control. In another embodiment enable user to follow other users of network based on searching of posted contents or posts of users of network by tapping or clicking on search result item associated embedded or integrated or presented follow button or icon or link or control to follow source(s) associated with search contents. In another embodiment enable user to follow other users of network based on visiting web site or profile page or web page of user(s) and tapping or clicking on profile page or webpage associated embedded or integrated or presented follow button or icon or link or control.

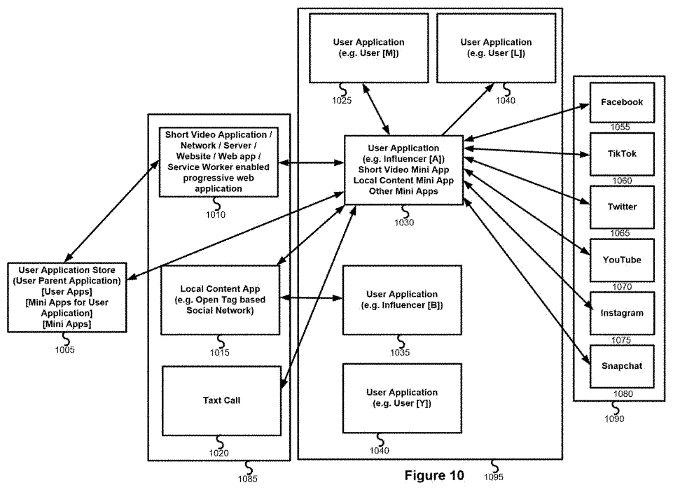

FIG. 10 illustrates user can use user application store 1005, parent application (centralized feed for viewing contents from multi sources, users, applications, preparing user generated content and publishing or sharing plurality types of contents or media) 1005 wherein user can search, match, select, download, install service worker enabled user progressive web applications, other in-network or connected progressive web applications, mini programs or mini applications, mini programs or mini applications for user applications and connect with external applications, progressive web applications, web sites via application programming interfaces (APIs) and web services. For example registered influencer user (A) 1030 install or use and register parent application 1005 and can create one or more types of user created contents and publish or share to one or more parent network directly connected or in-network applications 1010/1015/1020 or one or more connected external sources, web sites, applications, social networks 1090 connected via application programming interfaces (APIs) and web services. So followers of the user [A] on external applications, websites, social networks and networks 1090 can view posted contents on external networks 1090 and in-network applications 1010/1015/1020 via user application 1030. In an embodiment user 1095 can have more than one user applications 1085. In another embodiment each user application 1010/1015/1020 in multiple applications have same or different followers, connections, related users. In another embodiment followers, subscribers, registered users and connections of first application 1010 automatically becomes followers, subscribers, registered users and connections of second 1015 or subsequent application 1020. In another embodiment registered developers can register, upload, verify, list or publish one or more applications including progressive web applications 1085 which user application(s) 1095 can register, follow, subscribe, connect, update, disconnect, un-subscribe or un-follow. In another embodiment automatically or based on selections, preferences, privacy settings and rules, make member of one or more applications (e.g. Influencer user [A] 1030) and automatically or based on selections, preferences, privacy settings and rules, make followers, subscribers, connections from followers, subscribers, connections of other one or more applications of said user. In another embodiment based on settings of user application store or platform or server or server admin, automatically install applications including service workers enabled progressive web application(s) in users based on sponsorships, rules, preferences, settings, user specific requirements, auto match making and user activities, locations and user related data. In another embodiment user can subscribe, follow, connect with one or more group(s) of users including named group (e.g. family members of particular users), school groups, event members, clients, employees, partners, interacted entities, event participants, current location surround groups. In another embodiment based on mutual permission, automatically make followers, subscribers, registered members of first users to second users and/or automatically make followers, subscribers, registered members of second users to first users. In another embodiment automatically install one or more selected applications by admin to all or selected users of network and based on monitoring and tracking of usage, activities, interactions, actions, sharing, participations, updating ranking of applications for showing in prominent places within parent user interface.

In another embodiment platform can provide domain name service, payment services, storage services, listing service, login service content service, custom or template based automatic development services, marketing or promotion or creation of user base services for user application(s). In another embodiment based on customizable parts of app including travel, health, food, entertainment, domain or subject specific education, skill, job, business generate personal or user application which facilitates user in use day to day activities functions, view centralized feed, published contents from centralized interface, view logged activities related details and associated actions.

In another embodiment based on preferences and settings, user application can automatically share one or more types of data, content, settings with other one or more applications including user applications, in-network applications, mini applications and external 3^{rd} parties applications, databases, devices and websites.

In another embodiment user application 1030 can acquire stored followers and connections data, logged activities and reactions data from external 3^{rd} parties applications, databases, devices and websites 1090 via their application programming languages (APIs) and web services and one or more types of communications interfaces.

In another embodiment by using user application user can connect with friends and family or groups. Each can view different customized presentation of contents and actions, wherein customized presentation including different types of interface, color, fonts, actions for different groups of connections.

In another embodiment enabling user or developer to integrate or embedded or attach or share one or more applications including progress web application (PWAs) and user applications in/with/within/at/via one or more applications, websites, web pages, documents, profiles, emails, messages, status, posts, contents, media including text, photo & video, user interfaces and based on privacy settings enabling other all or selected or selected types of users to access full or part or selective part of user application(s). User can integrate application(s) via link, uniform resource locator (URL), icon, one or more types of control(s) including image, button, video, name which other users can invoke via said selecting said link, uniform resource locator (URL), icon, one or more types of control(s). In another embodiment enabling user to integrate or embedded one or more interface(s) or feature(s) of user application or full user application in/with/within/at one or more applications, websites, web pages, documents, profiles, emails, messages, status, posts, contents, media, user interfaces via uniform resource locator (URL), link, control, application programming interfaces (APIs), software development toolkits (SDKs) web services and communication interfaces.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

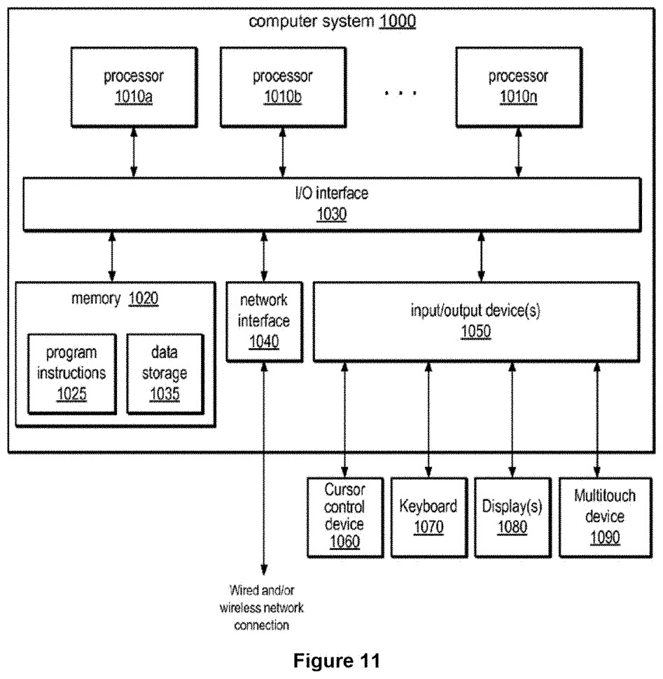

Various components of embodiments of methods as illustrated and described in the accompanying description may be executed on one or more computer systems, which may interact with various other devices. One such computer system is illustrated by FIG. 11. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 11, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations. Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense. In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object-oriented programming language(s). The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application. Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability. Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method. Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

I claim:

1. The method comprising: receiving, from the first computing device, a registration request, requesting registering and creation of a new account of the first user; registering and creating the new account for the first user; receiving, from the first computing device of a first user, a request to submit a user application or generated user application for listing and publication in a network; publishing or listing and making searchable, the user application in the network; receiving, from the second computing device of a second user, a request from a parent application, to open the user application of the first user of the plurality of user applications; opening the user application of the first user within or from the parent application of the second computing device of the second user.

2. The method of claim 1 wherein receiving a request from the parent application of client device to follow or connect or register user application and user application associated user; storing the follower or connection or registration information in the storage.

3. The method of claim 1 wherein receiving request from the parent application of the client device to display contextual or suggested or relevant or matched user applications based on following, connections, phone contacts, email contacts from one or more accounts, mutual connections, followers, followed sources, viewers, registered users of user on one or more external domains, applications and services based on social or professional network and instant messaging accounts, identified current location or location associated place or place associated contextual activities or checked-in place, identified entered pre-defined geofence, identified nearby users or one or more types of interacted contextual entities, monitored and tracked schedules, alarms, incoming calls, messages, contents and notifications, calendar entries, logged activities, actions, participations, interactions, transactions, locations, entities, updates, status, sharing, communication, collaboration, recognized scanned code including QR code, face or object or body, detected voice of nearby identified or contextual persons, voice command, search query, past search history, past user applications history, bookmarks, connection requests, contacts of contacts, required or assigned or searched or ending tasks, requirement specification, one or more types of user and connected users related data and profile, keywords, tags one or more types of filters, match making criteria, user preferences, privacy settings, date and time, rules and triggering of one or more types of pre-defined or updated triggers and executing of rules from pre-defined rules base and any combination thereof.

4. The method of claim 1 wherein receiving request from the parent application of the client device to unfollow particular followed source or particular user application; allowing to unfollow requesting user with said particular followed source.

5. The method of claim 1 wherein receiving request from the parent application of the client device to disconnect particular connection user or user application; disconnect requesting user with said particular connected user or user application.

6. The method of claim 1 wherein receiving search query from the parent application of the client device to search user applications or to search one or more types of contents and data associated with user applications; searching user applications and associated one or more types of contents and data based on search query and displaying search results, wherein each search result item associated with follow, connect, register or add control including button or link; and enabling searching user to select one or more search results and follow or connect or register with one or more selected users or user applications.

7. The method of claim 1 wherein in the event of a first user following or connecting or registering to a second user on a first network or an application or a platform or a website or a service, transferring pre-determined one or more types of data or contents including user profile, one or more types of reactions of first user and one or more types of posted contents of the second user to the second application or website or database or network related or associated to the second user.

8. The method of claim 1 wherein in the event of first user following or connecting or registering to a second user on first network or application or platform or website or service, transferring pre-determined one or more types of data or contents including user profile, one or more types of reactions of first user and one or more types of posted contents of the second user to the second application or website or database related or associated to the second user; and in the event of third user following or connecting or registering to a second user on second network or application or platform or website or service, transferring pre-determined one or more types of data or contents including user profile, one or more types of reactions of first user and one or more types of posted contents of the second user to the first application or website or database related or associated to the second user.

9. The method of claim 1 wherein receiving from the user, name of external domain or application or social network or website, unique identity or profile uniform resource locator (URL) on external domain or application or social network or website, profile photo associated with external domain or application or social network or website; receiving from the camera application of user device, live or real-time or current video or photo of user; matching user profile photo with said extracted image inside live or real-time or current video or photo of user based on face or body recognition; in the event of sufficiently matching of user profile photo with said extracted image inside live or real-time or current video or photo of user automatically or manually identifying data, statistics, analytics including number of followers, connections, contacts, viewers, views, posted contents, one or more types of actions and reactions on posted contents related to user on said external domain or application or social network or website; and determining or identifying eligibility and ranking of user or determining offer for user.

10. The method of claim 1 wherein allowing a parent application to access applications related to each user of a parent network; enabling users to follow or subscribe or connect or register one or more applications or users of the parent network associated with corresponding application; and enabling users to view received or displayed contents or call-to-actions from/of followed or subscribed or connected or registered sources on central interface or on application associated with followed or subscribed or connected or registered sources.

11. A system, comprising a server computer communicatively coupled to a network and comprising instructions that, when executed by a hardware processor on the server computer, cause the server computer to: receive, from the first computing device, a registration request, requesting registering and creation of a new account of the first user; register and create the new account for the first user; receive, from the first computing device of a first user, a request to submit a user application or generated user application for listing and publication in a network; publish or list and make searchable, the user application in the network; receive, from the second computing device of a second user, a request from a parent application, to open the user application of the first user of the plurality of user applications; open the user application of the first user within or from the parent application of the second computing device of the second user.

12. The system of claim 11 wherein receiving a request from the parent application of client device to follow or connect or register user application and user application associated user; store the follower or connection or registration information in the storage.

13. The system of claim 11 wherein receive request from the parent application of the client device to display contextual or suggested or relevant or matched user applications based on following, connections, phone contacts, email contacts from one or more accounts, mutual connections, followers, followed sources, viewers, registered users of user on one or more external domains, applications and services based on social or professional network and instant messaging accounts, identified current location or location associated place or place associated contextual activities or checked-in place, identified entered pre-defined geofence, identified nearby users or one or more types of interacted contextual entities, monitored and tracked schedules, alarms, incoming calls, messages, contents and notifications, calendar entries, logged activities, actions, participations, interactions, transactions, locations, entities, updates, status, sharing, communication, collaboration, recognized scanned code including QR code, face or object or body, detected voice of nearby identified or contextual persons, voice command, search query, past search history, past user applications history, bookmarks, connection requests, contacts of contacts, required or assigned or searched or ending tasks, requirement specification, one or more types of user and connected users related data and profile, keywords, tags one or more types of filters, match making criteria, user preferences, privacy settings, date and time, rules and triggering of one or more types of pre-defined or updated triggers and executing of rules from pre-defined rules base and any combination thereof.

14. The system of claim 11 wherein receive request from the parent application of the client device to unfollow particular followed source or particular user application; allow to unfollow requesting user with said particular followed source.

15. The system of claim 11 wherein receive request from the parent application of the client device to disconnect particular connection user or user application; disconnect requesting user with said particular connected user or user application.

16. The system of claim 11 wherein receive search query from the parent application of the client device to search user applications or to search one or more types of contents and data associated with user applications; search user applications and associated one or more types of contents and data based on search query and display search results, wherein each search result item associated with follow, connect, register or add control including button or link; and enable searching user to select one or more search results and follow or connect or register with one or more selected users or user applications.

17. The system of claim 11 wherein in the event of a first user following or connecting or registering to a second user on a first network or an application or a platform or a website or a service, transferring pre-determined one or more types of data or contents including user profile, one or more types of reactions of first user and one or more types of posted contents of the second user to the second application or website or database or network related or associated to the second user.

18. The system of claim 11 wherein in the event of first user following or connecting or registering to a second user on first network or application or platform or website or service, transferring pre-determined one or more types of data or contents including user profile, one or more types of reactions of first user and one or more types of posted contents of the second user to the second application or website or database related or associated to the second user; and in the event of third user following or connecting or registering to a second user on second network or application or platform or website or service, transferring pre-determined one or more types of data or contents including user profile, one or more types of reactions of first user and one or more types of posted contents of the second user to the first application or website or database related or associated to the second user.

19. The system of claim 11 wherein receive from the user, name of external domain or application or social network or website, unique identity or profile uniform resource locator (URL) on external domain or application or social network or website, profile photo associated with external domain or application or social network or website; receive from the camera application of user device, live or real-time or current video or photo of user; match user profile photo with said extracted image inside live or real-time or current video or photo of user based on face or body recognition; in the event of sufficiently matching of user profile photo with said extracted image inside live or real-time or current video or photo of user automatically or manually identify data, statistics, analytics including number of followers, connections, contacts, viewers, views, posted contents, one or more types of actions and reactions on posted contents related to user on said external domain or application or social network or website; and determine or identify eligibility and ranking of user or determining offer for user.

20. The system of claim 11 wherein allow a parent application to access applications related to each user of a parent network; enable users to follow or subscribe or connect or register one or more applications or users of the parent network associated with corresponding application; and enable users to view received or displayed contents or call-to-actions from/of followed or subscribed or connected or registered sources on central interface or on application associated with followed or subscribed or connected or registered sources.

21. A method of message distribution, comprising: receiving, from the first user, follower information indicative of one or more other users including second user and third user to be followed by the first user; storing the follower information in the storage; receiving from a first application associated with the first user from a first source, first content for distribution; receiving from a second application associated with the second user from a second source, second content for distribution; identifying, by a computer processor, followers of the second user, wherein the first user is among the followers; identifying, by a computer processor, followers of the third user, wherein the first user is among the followers; sending the message to the followers of the second user, including the first user; and sending the message to the followers of the third user, including the first user.

22. A system of message distribution, comprising a server computer communicatively coupled to a network and comprising instructions that, when executed by a hardware processor on the server computer, cause the server computer to: receive, from the first user, follower information indicative of one or more other users including second user and third user to be followed by the first user; store the follower information in the storage; receive from a first application associated with the first user from a first source, first content for distribution; receiving from a second application associated with the second user from a second source, second content for distribution; identify, by a computer processor, followers of the second user, wherein the first user is among the followers; identify, by a computer processor, followers of the third user, wherein the first user is among the followers; send the message to the followers of the second user, including the first user; and sending the message to the followers of the third user, including the first user.
